(19) United States
(12) Patent Application Publication
(10) Pub. No.: US 2012/0253890 A1
(43) Pub. Date: Oct. 4, 2012

(54) ARTICULATING VALUE-CENTRIC INFORMATION TECHNOLOGY DESIGN

(75) Inventors: Virendra Paliwal, Bangalore (IN); Sharad Elhence, Plano, TX (US); Ashoka Kota Ramachandra, Bangalore (IN); Venkata Subrahmanyam Goparaju, Bangalore (IN); Raj Joshi, Bangalore (IN); Satyendra Kumar, Bangalore (IN)

(73) Assignee: Infosys Limited, Bangalore (IN)

(21) Appl. No.: 13/109,924

(22) Filed: May 17, 2011

(30) Foreign Application Priority Data
Mar. 31, 2011 (IN) 1067/CHE/2011

(51) Int. Cl. G06Q 10/00

(52) U.S. Cl. 705/7.39

(57) ABSTRACT

A framework for articulating value-centric information technology design is presented. The framework can perform business value articulation, including establishing a relationship between change enablers and ultimate resulting business value. Key business process metrics of information technology services can be assessed. Change enablers can be identified. A business value articulation model can represent connections between change enablers and ultimate value to the organization. The framework assists an information technology service provider articulate how it can deliver higher business value to an organization.

### CROSS-REFERENCE TO RELATED APPLICATION

The application claims priority from Indian Application No. 1067/CHE/2011, filed Mar. 31, 2011, which is incorporated herein by reference.

### BACKGROUND

Information Technology (“IT”) has been widely deployed by organizations to improve efficiency and effectiveness of their businesses. Organizations continue to expend significant resources on IT to gain a competitive advantage.

Over the years, the perception of IT has progressed from being simply data storage to facilitating new business models. So, it has been widely accepted that IT contributes to performance of an organization. However, the precise relationship between resources expended and impact on the performance of the business is not very well established, despite that it is vitally important for IT service providers to know how to enhance the efficiency and effectiveness of IT service delivery such that business value of the client organization is enhanced.

As software engineering rapidly evolves with a dizzying array of advances in a variety of technologies, it becomes increasingly difficult to select which of the technologies are appropriate and which will have a meaningful impact on business value for the organization.

Although there have been a variety of advances, there remains room for improvement.

### SUMMARY

A variety of techniques can be used for articulating business-value-centric information technology design.

Relationships between change enablers and ultimate business value to the organization can be established.

A business value articulation model can be constructed to represent various elements and the relationships between the elements.

Identification of appropriate change enablers can be achieved.

An end-to-end framework can take into account the business and IT context of an organization in determining which business process metrics can be improved and which change enablers are needed to improve the metrics.

As described herein, a variety of other features and advantages can be incorporated into the technologies as desired.

The foregoing and other features and advantages will become more apparent from the following detailed description of disclosed embodiments, which proceeds with reference to the accompanying drawings.

### BRIEF DESCRIPTION OF THE FIGURES

FIG. 1 is a block diagram of an exemplary system implementing the business value articulation technologies described herein.

FIG. 2 is a flowchart of an exemplary method of implementing the business value articulation technologies described herein.

FIG. 3 is a block diagram of an exemplary system implementing the business value articulation technologies described herein via a business value articulation model.

FIG. 4 is a flowchart of an exemplary method of implementing the business value articulation technologies described herein via a business value articulation model.

FIG. 5 is a block diagram of another exemplary system implementing the business value articulation technologies described herein via a business value articulation model.

FIG. 6 is a flowchart of another exemplary method of implementing the business value articulation technologies described herein via a business value articulation model.

FIG. 7 is a block diagram of an exemplary node for a business value articulation model.

FIG. 8 is a block diagram of exemplary business-domain-independent services.

FIG. 9 is a block diagram of an exemplary system for achieving business value articulation.

FIG. 10 is a flowchart of an exemplary method of achieving business value articulation.

FIG. 11 is a block diagram of an exemplary system filtering change enablers via a business value articulation tool suite.

FIG. 12 is a flowchart of an exemplary method of filtering change enablers via a business value articulation tool suite.

FIG. 13 is a block diagram of an exemplary system applying a business value articulation framework.

FIG. 14 is a block diagram of an exemplary business value articulation model.

FIG. 15 is a flowchart of an exemplary method of applying a business value articulation framework via a business value articulation model.

FIG. 16 is an exemplary general framework for achieving business value articulation.

FIG. 17 is an exemplary comprehensive framework for achieving business value articulation.

FIG. 18 is an exemplary table of exemplary business processes.

FIG. 19 is a continuation of FIG. 18.

FIG. 20 is an exemplary table of business process levers related to business process names.

FIG. 21 is an exemplary partially-completed model for business value articulation.

FIG. 22 is an exemplary further completed model for business value articulation.

FIG. 23 is an exemplary further completed model for business value articulation.

FIG. 24 is an exemplary business value articulation model for the banking industry in the service/maintenance domain.

FIG. 25 is an exemplary business value articulation model for the banking industry in the service/independent validation solution domain.

FIG. 26 is an exemplary business value articulation model for a broadline retailer in the service/development domain.

FIG. 27 is an exemplary business value articulation model for order processing.

FIG. 28 is a block diagram of an exemplary computing environment suitable for implementing any of the technologies described herein.

### DETAILED DESCRIPTION

IT service providers and IT organizations of an enterprise typically understand and deliver value by focusing on day-to-day concerns (e.g., the so-called “keeping the lights on” syndrome) or technical metrics (e.g., orders processed per hour). While such an understanding is helpful, the technologies described herein can be structured to provide business value to the enterprise. The technologies can assist in articulation of connection between an IT service provider's proposed solution and ultimate business value to the enterprise.

Another area of weakness for IT service providers and IT organizations is focusing on reducing year-over-year costs or improving quality of service (e.g., as part of a Service Level Agreement). Such concerns may be important but can overlook how to engineer an IT service to deliver higher business value.

### Example 1

### Exemplary Overview

The technologies described herein can be used for a variety of business value articulation scenarios. A business value articulation framework can make use of the business value articulation models described herein. Adaptation of the technologies can shift emphasis in IT design from addressing perceived immediate needs to providing superior business value to an organization. Such an approach can be particularly informative and persuasive when presented by an IT service provider as part of a proposal for services.

### Example 2

### Exemplary Organization

In any of the examples herein, an organization can be a business entity or business enterprise, whether for profit or non-profit. In practice, the organization can be a client of an information technology services provider. Other variations include a subdivision or department of a larger business entity. The organization can be an internal client of a larger business entity.

### Example 3

### Exemplary IT Service Provider

In any of the examples herein, the technologies can be applied by an information technology services provider to a client organization. For example, as part of a proposal to the client organization, the information technology service provider can present business value articulation results to persuade the client organization that investment in the proposed technologies will result in enhanced business value for the client organization.

### Example 4

### Exemplary Business Value

In any of the examples herein, business value for an organization can be quantified in a variety of ways. Any measureable improvement in business operations (e.g., as a result of work done by an IT services vendor) can be called “business value.” Examples include financial business value (e.g., increasing revenue, reducing cost, or reduction in working capital) or a positive impact on a qualitative attribute of business value (e.g., an incremental improvement in the qualitative attribute that can be measured and quantified). Some measures of business value are quantitative, and some are qualitative (but measurable).

Financial business value can be expressed in free cash flow, leverage ratio, growth, revenue, profit, and the like. Non-financial business value can include customer satisfaction and the like.

Free cash flow (FCF) is a measure of the after-tax cash generated as a result of increased revenue, reduced cost, or reduction in working capital driven by a project. Free cash flow can be used by financial analysts to measure the financial contribution of investments (e.g., in change enablers).

Net present value (NPV) can be used to measure free cash flow and is a standard measure of return on investment (ROI). Net present value can be used to establish the time value of a series of cash flows over a defined period of time. Net present value can be used to evaluate projects from a financial standpoint.

A leverage ratio can be calculated as the ratio between the cumulative free cash flow and the total cost of an information technology services project, including one time and recurring costs. The leverage ratio should be based on a time horizon (e.g., three-five years). The leverage ratio can be presented as a differentiator between the IT service provider and its competitors.

### Example 5

### Exemplary Business Value Elements

In any of the examples herein, business value elements can include any one or more selected from the following: increase in revenue, reduction in cost, reduction in working capital, market share, capital investment, business risk, regulatory compliance, improved time to market, brand value, company reputation, customer satisfaction, employee satisfaction, product portfolio, service portfolio, geographic coverage, employee retention, company culture, being an employer of choice, innovation, and greenness (e.g., reduction in environmental impact).

Business value elements are sometimes called “value levers” when used in conjunction with the technologies herein and can be a measureable (e.g., qualitative, quantitative, or both) component or dimension of business value that represents how an organization creates value using a portion or all of its business processes and supporting operations.

Although their representation is tangible, the represented business value elements can include tangible and intangible (but quantifiable) measures.

Three value levers (e.g., revenue, cost, and working capital) can deliver free cash flow (FCF).

In any of the examples herein, a particular business value element can be an element of a business value articulation model. A stored element can indicate a type of business value without indicating a calculated amount.

### Example 6

### Exemplary System Employing a Combination of the Technologies

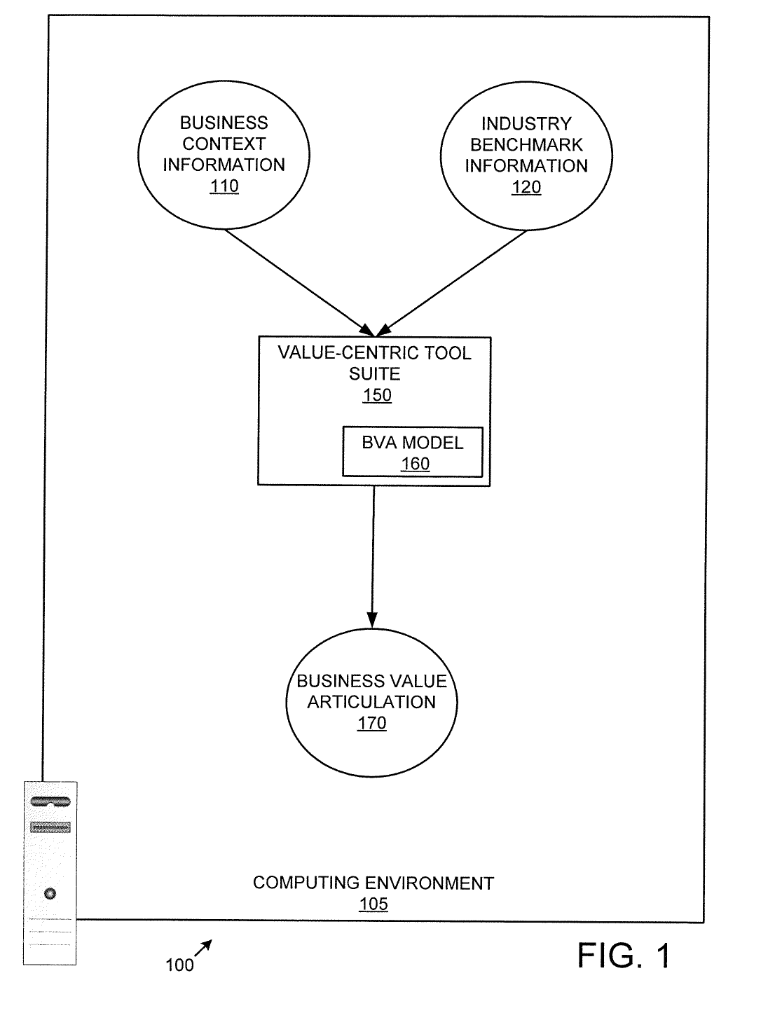

FIG. 1 is a block diagram of an exemplary system 100 implementing the business valuation articulation technologies described herein. In the example, one or more computers in a computing environment 105 implement a value-centric tool suite 150 that accepts as input business context information 110 and industry benchmark information 120.

The tool suite 150 can include a business valuation articulation model 160 as described herein. The tool suite 150 can generate business value articulation 170 (e.g., via the model 160).

In practice, the systems shown herein, such as system 100 can be more complicated, with additional functionality, more complex articulations, and the like.

In any of the examples herein, the inputs (e.g., business context information 110, industry benchmark information 120, and the like) and outputs (e.g., business value articulation 170) can be stored in one or more computer-readable storage media.

### Example 7

### Exemplary Method of Applying a Combination of the Technologies

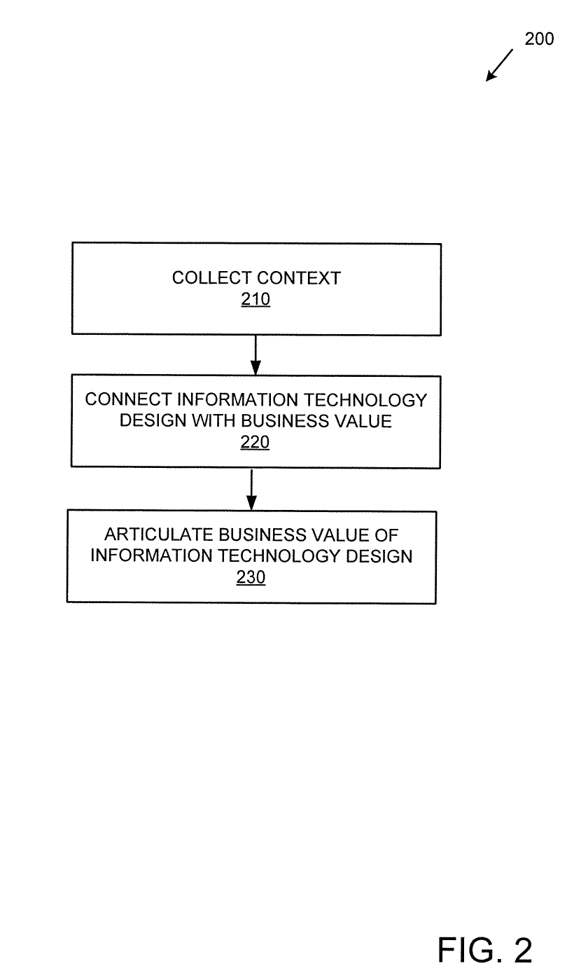

FIG. 2 is a flowchart of an exemplary method 200 of implementing the business value articulation technologies described herein and can be implemented, for example, in a system such as that shown in FIG. 1. The technologies described herein can be generic to the specifics of operating systems or hardware and can be applied in any variety of environments to take advantage of the described features.

At 210, context of the business organization for which business value articulation is to be performed is collected. Any of the context information described herein can be collected and can include industry benchmark information.

At 220, an aspect of information technology design is connected with business value based on the context. For example, in a business value articulation model, representations of change enablers can be connected with representations of ultimate business value to the organization. Such connections can be based on the context information. Connecting can comprise representing at least one change enabler based on the context information. Connecting can comprise establishing a multi-step connection between the representation of the change enabler and the ultimate business value to the organization (e.g., as represented by an element in a business value articulation model).

At 230, the business value of the information technology design can be articulated. Such articulation can comprise indicating the multi-step connection between the change enabler and the ultimate business value to the organization. As described herein, the connection can be directed to indicate influence of one element on another in the model.

The method 200 and any of the methods described herein can be performed by computer-executable instructions stored in one or more computer-readable media (e.g., storage or other tangible media) or one or more computer-readable storage devices.

### Example 8

### Exemplary Client Context Information

In any of the examples herein, context for a client organization can include business context information (e.g., information about the client's business), industry benchmark information (e.g., observed metrics for others in the same industry as the client organization), information technology context information (e.g., the current state of the information technology systems of the organization), and the like.

For example, if developing or maintaining an order processing service for a client, an IT service provider can collect quantitative and qualitative but measureable information regarding performance of the client's business (e.g., for a telecom client: percent of orders failed, percent of orders lost, average completion time of the order, percent of orders completed within the agreed upon service level agreement with the customer, customer feedback scores on completed orders, etc.).

The collected information can indicate how the client is faring in the metrics vis-à-vis its peers and competitors. The information can be obtained from industry benchmarks. When compared with the industry benchmarks, the IT service provider can recommend, or the client can suggest, based on their strategy and goals, what improvements are required in the metrics and in turn the business processes. The IT service provider can then design its IT services to impact the metrics and enable the client to achieve its goal.

### Example 9

### Exemplary Client Organization Context Dimensions

For purposes of analysis, in any of the examples herein, client context can be represented by context dimensions that can be given ratings, rankings, or both. For example, dimensions of domain complexity, platform stability, process, maturity, architecture/code/application characteristics can be defined as client context dimensions.

Determination of ratings for such dimensions can be accomplished by measuring attributes for the dimensions. Dimensions can have respective attributes. For example, domain complexity can depend on attributes such as familiarity with domain, complexity of business process, and the like. Platform stability can depend on attributes such as number of tickets, number of change requests, SLA compliance, and the like. Process maturity can depend on attributes such as process standardization, adherence, metrics, and the like. Architecture/code/application characteristics can depend on attributes such as code quality-maintainability, complexity, architecture complexity, number of technology platforms and different interface, number of users, and the like.

To facilitate rating, attributes can be given a score. For example, a High/Medium/Low rating can result in a score of 3/2/1. Attribute scores can be combined (e.g., via weightings) to result in a score for the respective dimension.

### Example 10

### Exemplary Business Value Articulation

In any of the examples herein articulation of business value can take various forms. Articulation typically is geared to a particular organization. So, the business value, to the organization, can be articulated. For example, a connection between business value and a proposed solution can be articulated via business value connection articulation.

Articulation can include determining and storing a business value articulation model; representing any one or more of the connections within elements in such a model; representing which elements influence which; representing the path from a change enabler to ultimate business value; outputting a filtered list of change enablers; and the like. Articulation can also include displaying any of the above for consideration by a user.

Such articulation can be particularly beneficial as a part of the process of solution proposal to an organization.

Articulating business value of services provided by an IT service provider if they were to implement a change enabler can comprise presenting the change enabler, by an information technology services provider, as a differentiator over a competing information technology services provider. The differentiator can be presented as unique in the marketplace.

### Example 11

### Exemplary Business Value Articulation Model

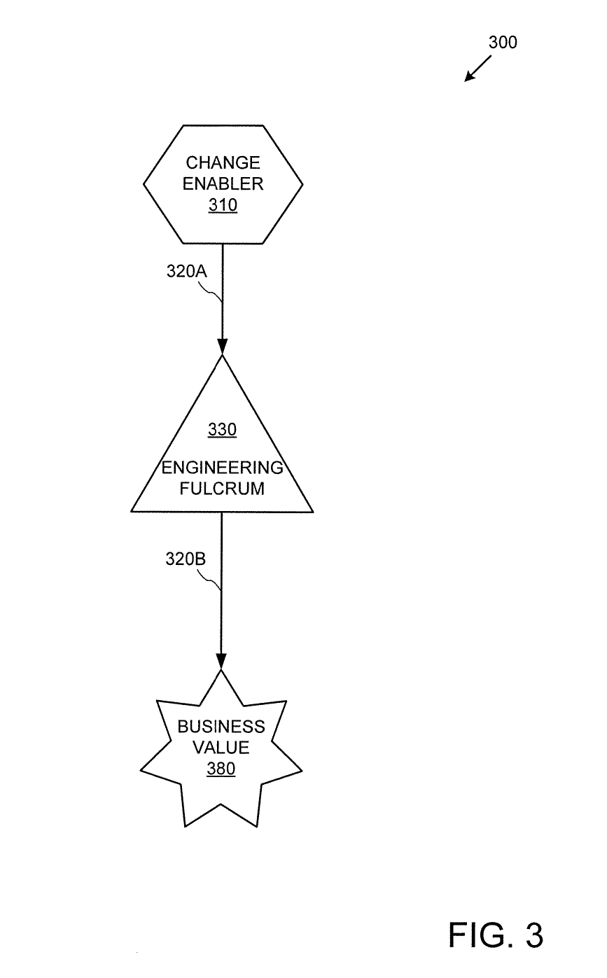

FIG. 3 is a block diagram of an exemplary system 300 implementing the business value articulation technologies described herein. In the example, a business value articulation model 300 represents a connection between an information technology change enabler 310 and a representation 380 of ultimate business value (e.g., a business value element).

In the example, the connection passes through a representation of an engineering fulcrum 330 (e.g., one or more engineering fulcrum elements).

In any of the examples herein, a tool can present a business value articulation model (e.g., 300), an indication of the connections therein, and the like.

In practice, the model 300 can include more elements, more levels, and the like. Typically, there is a multi-step connection (e.g., with multiple connections 320A and 320B) between the change enabler 310 and ultimate business value 380 to the organization.

Any of the business process value articulation models herein can be represented by nodes representing elements of the model and connections therebetween (e.g., stored in one or more computer-readable storage media or one or more computer-readable storage devices).

### Example 12

### Exemplary Method of Applying a Combination of the Technologies

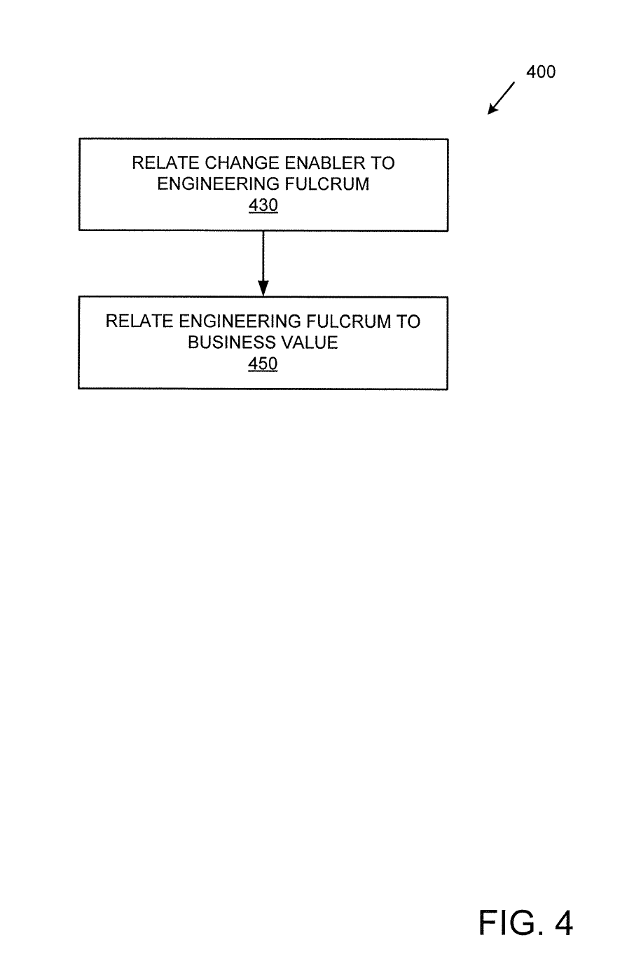

FIG. 4 is a flowchart of an exemplary method 400 of implementing the business value articulation technologies described herein and can be implemented, for example, in a system such as that shown in FIG. 3. The method 400 can build a business value articulation model.

Creating a business value articulation model can comprise creating and storing, in one or more computer-readable media, nodes representing various identified elements and relating (e.g., connecting) the elements to each other via connections representing influence of one element on another.

At 430, a change enabler element is related to an engineering fulcrum element (e.g., via a connection between nodes representing the elements).

At 450, the engineering fulcrum element is related to the business value element (e.g., via a connection between nodes representing the elements).

In any of the examples herein, the order of the shown actions can be re-arranged. For example, it is entirely possible to start with a connection from the engineering fulcrum to business value and consequently connect the change enabler to the engineering fulcrum.

### Example 13

### Exemplary Other Business Value Articulation Model

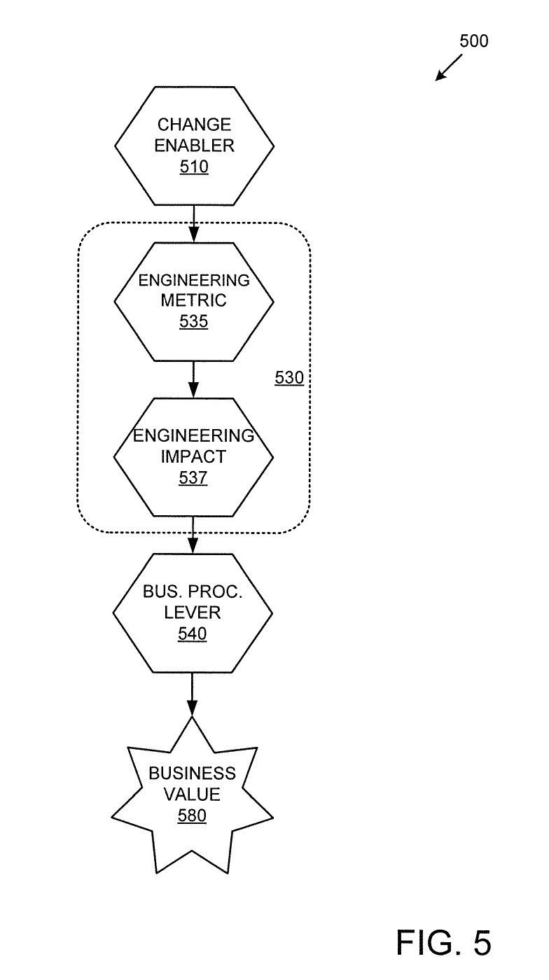

FIG. 5 is a block diagram of an exemplary system 500 implementing the business value articulation technologies described herein. In the example, a business value articulation model 500 represents a connection between an information technology change enabler 510 and a representation 580 of ultimate business value (e.g., a business value element).

In the example, the connection passes through a representation of an engineering fulcrum 530, and a representation of a business process lever 540 (e.g., a business process metric element).

The engineering fulcrum 530 can comprise an engineering metric 535 and engineering impact 537. In practice, the engineering metric 535 impacts the engineering impact 537. However, as described herein, when constructing a model, selection of engineering metric 535 can be based on engineering impact 537 (e.g., the model can be built in reverse order from a cause-effect order).

### Example 14

### Exemplary Method of Applying a Combination of the Technologies

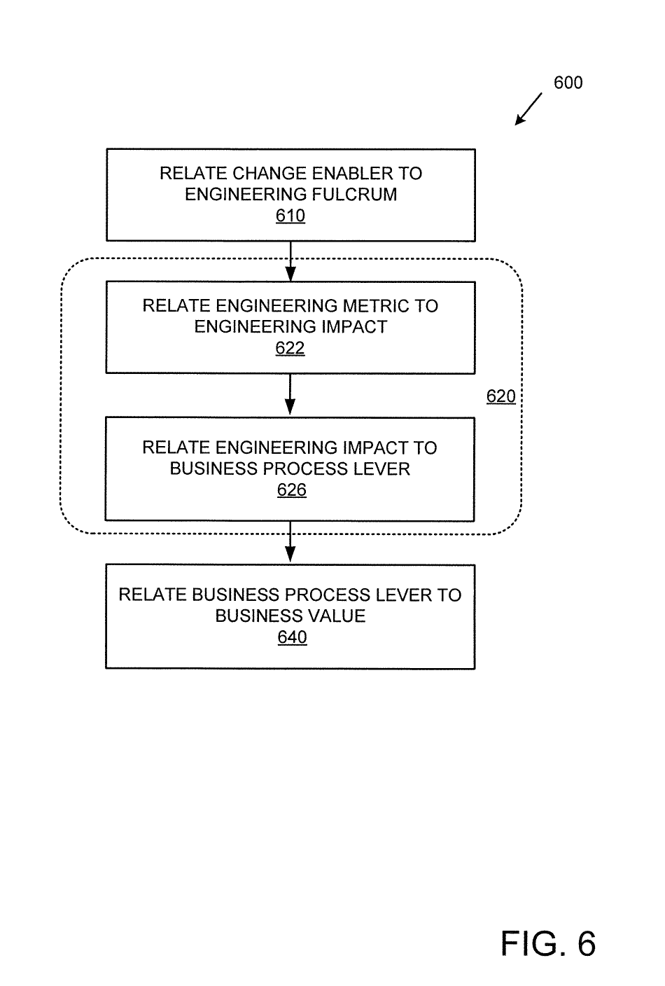

FIG. 6 is a flowchart of an exemplary method 600 of implementing the business value articulation technologies described herein and can be implemented, for example, in a system such as that shown in FIG. 5. The method 600 can build a business value articulation model.

At 610, a change enabler is related to an engineering fulcrum (e.g., engineering impact) (e.g., via a connection between the elements representing them).

At 620, the engineering fulcrum can be related to the business process lever (e.g., via a connection between elements representing them).

The relating 620 can comprise relating an engineering metric to engineering impact 622 and relating the engineering impact to a business process lever 626.

At 640, the business process lever is related to business value (e.g., via a connection between elements representing them).

### Example 15

### Exemplary Nodes

In any of the examples herein, various elements of a business value articulation model can be represented as nodes in the model. The node can store an identification of the element and the element type (e.g., “increasing revenue” and “business value” type). The nodes thus represent a concept of business value articulation in a concrete way and allow connection between elements to illustrate relationships between them.

Possible element types include those representing aspects of information technology design, such as change enabler, engineering fulcrum (e.g., engineering metric, engineering impact), and business process metric. Another possible element type can represent business value.

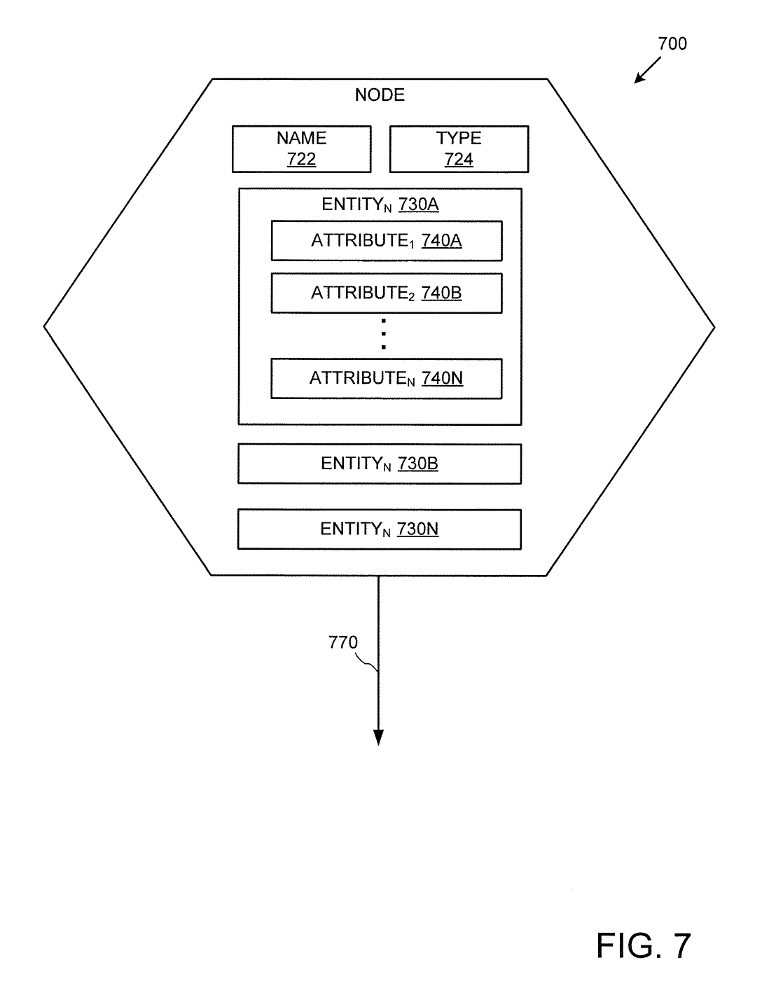

FIG. 7 is a block diagram of an exemplary business value articulation node 700. In the example, the node 700 includes a node name 722 and a node type 724, which indicates a type of the node. The node 700 can also include one or more entities 730A-N having respective attributes 740A-N.

A connection 770 from the node 700 to other nodes can be represented as part of the node 700.

In practice, the node 700 can be stored in computer-readable storage media as one or more data structures.

### Example 16

### Exemplary Node Types

In any of the examples herein, a node can be any of the types described herein (e.g., change enabler, engineering metric, engineering impact, operational lever, value lever, and the like).

### Example 17

### Exemplary Node Entities

In any of the examples herein, a node can have one or more node entities appropriate for the node. The entities can vary based on the type of node. Such entities can be measurable qualities of an IT system (e.g., availability, cycle time, quality, scalability, and the like). The node entities are typically implemented as one or more attributes (e.g., attribute name/attribute value pairs).

For example, an engineering metric node may have a node entity such as availability. Availability can have attributes indicating IT service (for which the entity can be used), a measure of the entity (e.g., how the entity is measured), nature of measure (e.g., qualitative, quantitative, etc.), entity category (e.g., engineering dependent, resource skill dependent, etc.).

Implementations in spreadsheets or databases can be supported. For example, entities can be stored as line items in a spreadsheet, records in a database, and the like. In such a case, a node can be represented by the aggregated entities.

### Example 18

### Exemplary Connections

In any of the examples herein, a connection can be stored between elements to show a relationship between them. Relating two elements can take the form of storing such a connection (e.g., an edge between nodes representing the elements). The connection can be directed (e.g., have a direction) as shown by arrowheads in the drawings.

Connections can represent a cause-and-effect relationship. A connection denotes that that one element is modeled as influencing (e.g., causes, impacts, or the like) another element in the model. For example, increasing availability of a system will result in reduction of a number of failed transactions, which will result in an increase in revenue. Such a relationship can be shown by storing three nodes representing the three nodes and a connection directed from “increasing availability” to “reduction in number of failed transactions.” Another connection can be directed from “reduction in number of failed transactions” to a node representing the element “increase in revenue.”

A multi-step connection typically is directed ultimately (e.g., transitively via connections to intermediary elements) to a business value element, which is sometimes called “ultimate business value” because the framework is concerned with demonstrating that the information technology services will ultimately lead to increased business value to the organization.

There can be many-to-many relationships between elements (e.g., one change enabler can impact multiple engineering metrics, one engineering metric can be impacted by more than one change enabler, etc.).

### Example 19

### Exemplary Change Enablers

In any of the examples herein, change enablers can be specific capabilities offered by an IT service provider within a business-domain-independent service that add measurable business value to the organization. Change enablers can be elements incorporated into the design of an IT service solution. In practice, an IT service provider can include providing one or more change enablers as part of a solution proposal to the organization. As such, the change enabler can serve as an indicator of a collection of capabilities offered as a bundled unit to the organization.

A variety of change enablers are described herein and can be categorized under the following change enabler categories: testing (e.g., test automation); maintenance (e.g., knowledge reuse); collaboration; knowledge management; business process modeling; distributed software development; application reengineering; performance testing; performance tuning; database design; and the like.

Change enablers include collections of software and services that further any of the above change enabler categories. For example, use of the Microsoft® SharePoint® platform is a change enabler that can be implemented by any of a variety of IT service providers to further collaboration.

Specific change enablers can be generic to the IT service provider; however, change enablers can also be defined to differentiate the providing IT service provider from its competitors. A change enabler can be identified by a change enabler identifier, which can indicate a description of specific services offered by an IT service provider within one of the change enabler categories.

In practice, an IT service provider may have a wide array of service offerings that it markets and touts as differentiators in the IT services marketplace. Such service offerings can be represented as change enablers by the technologies described herein. Thus, such service offerings can be filtered to those circumstances in which they are appropriate. Further, ultimate business value can be demonstrated to assist in marketing such offerings to organizations that will benefit from adoption.

### Example 20

### Exemplary Engineering Fulcrums

In any of the examples herein, an engineering fulcrum can be engineering metrics, engineering impacts, or combinations thereof. The fulcrum can serve as an intermediate element which relates change enabler elements to business value elements.

### Example 21

### Exemplary Engineering Metrics

In any of the examples herein, an engineering metric can be metrics that measure the efficiency and effectiveness of a change enabler within the organization by business-domain-independent service.

An engineering metric can be chosen for a particular business value articulation model based on its effect to improve one or more particular engineering impacts. Knowing which engineering metric is represented in a business value articulation model can facilitate determination of a respective change enabler.

A variety of engineering metrics are described herein and include time to resolution, number of high severity tickets, defect removal efficiency, number of releases/patches delivered without defects, and the like.

### Example 22

### Exemplary Engineering Impacts

In any of the examples herein, an engineering impact can serve as the engineering fulcrum of the business value articulation framework that links business-domain-independent IT services with business process levers and value levers.

An engineering impact can define a specific engineering outcome of a business-domain-independent IT service which in turn facilitates the improvement of a business process and thereby helps create business value.

Engineering impacts are also sometimes called a “system attribute,” “application attribute” or “IT attribute” herein.

A variety of engineering impacts are described herein and include improvement in system availability, reduction in cycle time, improvement in quality, increase in scalability, and the like.

An engineering impact can be chosen for a particular business value articulation model based on its effect to improve one or more particular business process metrics. Knowing which engineering impact is represented in a business value articulation model can facilitate selection of a respective engineering metric (e.g., that can be improved).

### Example 23

### Exemplary Business Processes

In any of the examples herein, a business process can be any process that impacts the business of the organization. In practice, such business processes can incorporate information technology.

### Example 24

### Exemplary Business Process Levers

In any of the examples herein, a business process lever can be a business process metric used to impact a business outcome (e.g., business value).

### Example 25

### Exemplary Business Process Metric

In any of the examples herein, a business process lever can be a business process metric used to impact a business outcome (e.g., business value). A business process metric can also be considered a candidate business process lever.

A business process metric can reflect the efficiency, effectiveness, or both of a business process within the broader business process hierarchy of the organization.

A specific improvement in a business process because of the engineering impact of business-domain-independent IT services can be measured by the business process metric.

The metric can exist at different levels of a business process (e.g., Level 0, Level 1, etc.).

A variety of business process metrics are shown herein and include increase in revenue transactions, improve efficiency of warehouse operations, reduce time-to-market, and the like.

A business process metric can be chosen for a particular business value articulation model based on its effect to address strategy, one or more pain points, one or more identified areas for improvement, or comparison with industry benchmarks. Knowing which business process metric is represented in a business value articulation model can facilitate selection of a respective engineering impact (e.g., that improves the business process metric).

### Example 26

### Exemplary Business-Domain-Independent Services

In any of the examples herein, exemplary business-domain-independent services (sometimes called “horizontal services”) can include maintenance services, independent validation (and testing) services (IVS), and the like. Business-domain-independent services can be any services that are not business-domain specific and have similar characteristics in terms of skills, how the services are delivered, etc., when they are provided in various business verticals (e.g., insurance, banking, retail, etc.).

In a business value articulation model, business-domain-independent services elements can include the change enablers, engineering metrics, and engineering impact.

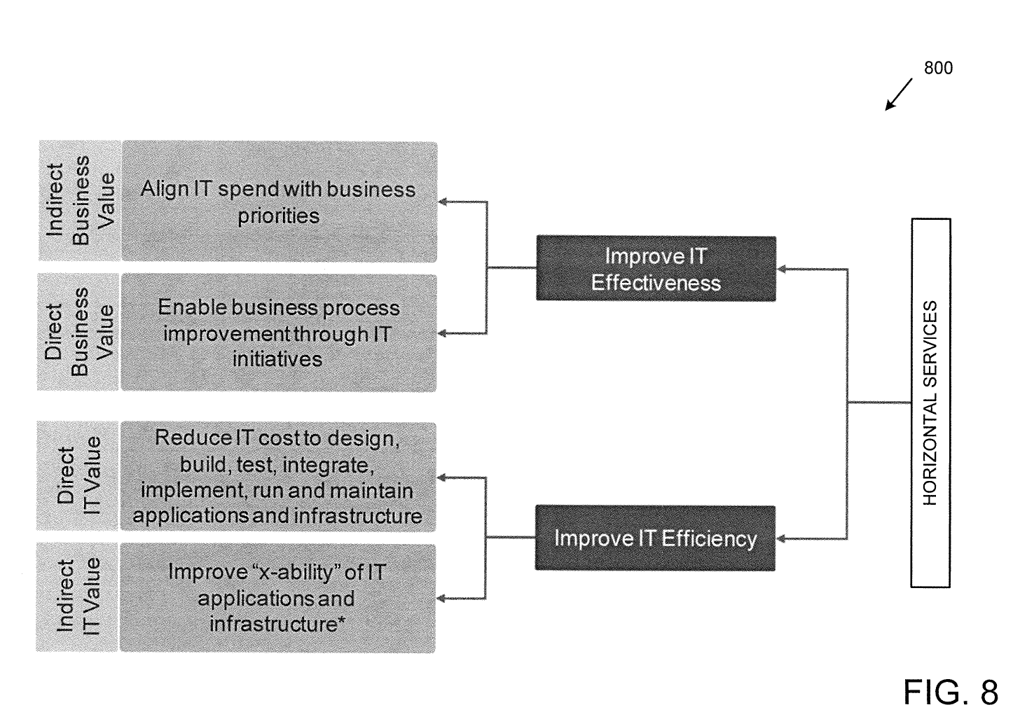

FIG. 8 is a diagram 800 of exemplary business-domain-independent services. In the example, IT effectiveness and efficiency are illustrated. Business-domain-independent services are employed to improve IT effectiveness, improve IT efficiency, or both.

The term “x-ability” includes availability, reliability, maintainability, scalability, predictability, and usability. Any of the shown actions can be elements in a business value articulation model as described herein.

Direct business value and direct IT value can impact free cash flow, and indirect IT value and indirect business value can impact competitive positioning.

### Example 27

### Exemplary System Achieving Business Value Articulation

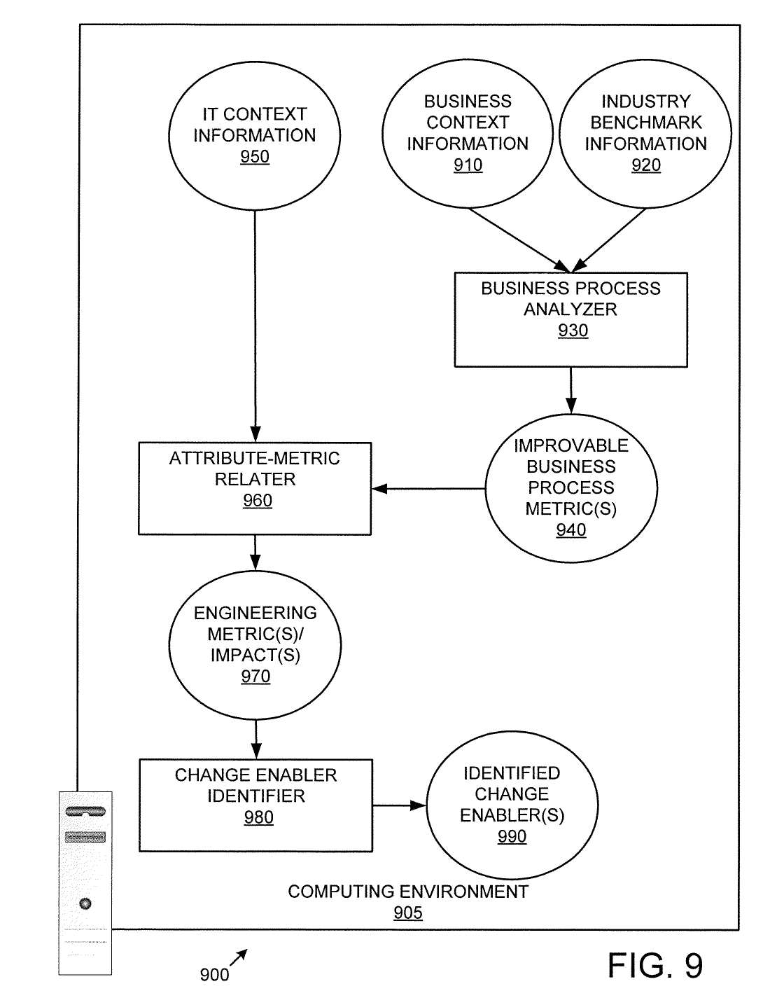

FIG. 9 is a block diagram of an exemplary system 900 for achieving business value articulation in a computing environment 905. In the example, business context information 910 for an organization and industry benchmark information 920 for the organization are used as input to a business process analyzer 930, which outputs improvable business process metrics 940 for business processes of the organization based on the inputs.

The improvable business process metrics 940 and IT context information 950 for the organization are used as input to an attribute-metric relater 960, which outputs engineering metric(s) and impact(s) (e.g., to identify which engineering metrics and impacts can serve as engineering fulcrums).

The metric(s) and impact(s) 970 are used as input to a change enabler identifier 980, which outputs one or more identified change enablers 990.

As progress through the process is achieved, a business value articulation model can be built and connected to represent a path from the change enabler back to the business process metric and to ultimate business value. In the example, the model is built from the business value end backward (e.g., in terms of influence direction within the organization) to the change enabler end.

### Example 28

### Exemplary Method of Achieving Business Value Articulation

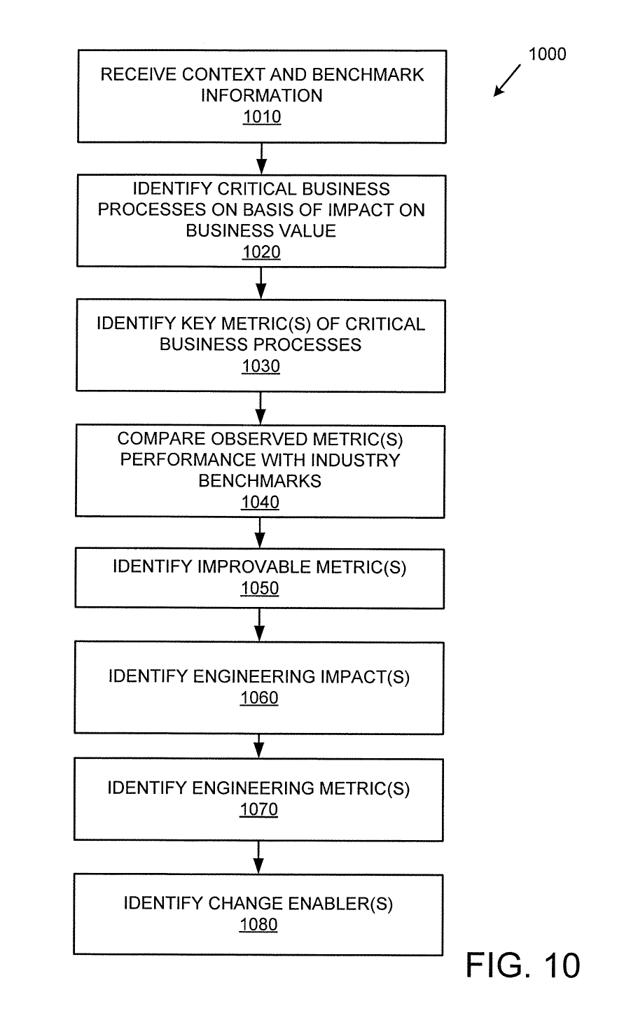

FIG. 10 is a flowchart of an exemplary method 1000 of achieving business value articulation and can be used, for example, in a system such as that shown in FIG. 9. In the example, the method results in identified change enablers for the organization. In parallel, a method can build a business value articulation model, connecting nodes representing the various elements identified during the method.

At 1010, context and benchmark information is received. For example, IT context information for an organization (e.g., IT attributes), business context information for the organization, industry benchmark information for the organization, and the like can be received.

At 1020, the critical business processes of the organization are identified on basis of impact on business value for the organization. The specific element of business value can be identified as well.

At 1030, key business process metrics of the identified critical business processes are identified.

At 1040, observed performance of the key metrics are compared with industry benchmarks.

At 1050, out of the key business process metrics, improvable metrics can be identified. For example, it can be determined for which key metrics the organization is exhibiting poor performance (e.g., relatively as compared to the industry benchmarks).

At 1060, one or more engineering impacts likely to improve respective of the identified business process metrics can be identified.

At 1070, one or more engineering metrics likely to improve respective of the identified engineering impacts can be identified.

As a part of the process, ratings for IT attributes can be transformed into ratings for organization context dimensions. Also, ratings for the engineering metrics (e.g., and engineering impacts, engineering fulcrums, and the like) can be derived from the ratings for the context dimensions. The engineering metrics ratings can indicate which of the engineering metrics are most improvable.

At 1080, change enablers for facilitating improvement in the engineering metrics can be identified.

As the process is performed, nodes representing the identified elements (e.g., business value elements, business process metrics, engineering impacts, engineering metrics, and change enablers) can be created (e.g., represented in a model). The nodes can be connected to show directed relationships between them. As a result, a path from a change enabler to ultimate business value to the organization is created in the model, which articulates how business value will result from adopting the change enablers in the organization.

### Example 29

### Exemplary Method of Identifying Key Metrics of Identified Critical Business Processes

In any of the examples herein, key metrics of identified critical business processes can be identified in a variety of ways.

For example, the relevant metrics for the set of business processes whose IT systems are being maintained, tested, or to be developed can be identified.

In the context of the entity's business strategy or goals, metrics that are relevant for tracking/improvement can be listed (e.g., those metrics which would have impact on the intended outcomes of a strategy are listed).

From the list, the metrics that can be meaningfully impacted by the IT service under consideration can be identified in a short list.

From the short listed business process metrics, the ones that would have maximum impact on the business value and have highest feasibility of improvement can be prioritized.

In subsequent stages of business value articulation, the metrics can then be evaluated in terms of the effort and cost it would take to improve, leverage, etc. For example, NPV can be calculated and prioritized.

### Example 30

### Exemplary Transformation of IT Attributes into Organization Context Dimension Ratings

In any of the examples herein, aspects of an organization's context can be transformed into organization context dimension ratings. For example, ratings for IT attributes of the organization can be transformed into ratings for the organization's context dimensions.

For example, weightings (e.g., fractions) can be assigned to the client context attributes and the weighted numbers added together, resulting in a rating. If the scores are based on a High/Medium/Low rating (e.g., 3/2/1), the weighted scores can be combined to result in a similar score (e.g., in a range between 1 and 3).

### Example 31

### Exemplary Derivation of Engineering Metric Ratings from Context Dimensions Ratings

In any of the examples herein, engineering metric ratings can be derived from context dimensions ratings.

Based on the client organization's overall IT strategy, weightings can be assigned for various client organization context dimensions for engineering metrics, based on perceived impact to the engineering metric. Using the weightings, ratings for the engineering metrics can be derived from the ratings for the context dimensions.

For example, percentages for engineering metrics can be assigned to the various client organization context dimensions so that they sum to 100%. Application of the dimension ratings to such weights and then summing them will result in scores in a range similar to those for the context dimensions for convenience of determination.

As a result, if High/Medium/Low ratings are used for the context dimensions, the engineering metrics can have similar ratings. To handle decimal values, ranges can be established (e.g., 2.4-3=high, 1.8-2.4=medium, less than 1.8=low). Thus, a list of the engineering metrics can present the high/medium/low category ratings for convenience.

Using such a technique, those engineering metrics with the lowest ratings are those that can be most improved. Thus, a list of the metrics can indicate which are most improvable.

### Example 32

### Exemplary Weightings

In any of the examples herein, weightings for determining engineering metrics can be based on the client organization's overall IT strategy. The impact on a context dimension on the value delivered to the client organization can be reflected in the weighting for respective engineering metrics (e.g., impacts). An exemplary table is shown below:

| Engineering | Client Context Dimensions | | | |
|---|---|---|---|---|
| Metric | Domain | Platform | Process | Arch/Code |
| (Impact) | Complexity | Stability | Maturity | Characteristics |
| Availability | 15% | 40% | 20% | 25% |
| Cycle Time | 20% | 10% | 30% | 40% |
| Scalability | 20% | 20% | 10% | 50% |
| Performance | 10% | 40% | 10% | 40% |
| Usability | 30% | 20% | 30% | 20% |
| Correctness | 35% | 25% | 15% | 25% |
| of output | | | | |
| Total Cost of | 5% | 10% | 35% | 50% |
| Ownership | | | | |
| Functional | 40% | 10% | 25% | 15% |
| Enhancement | | | | |

In the example, if the platform stability is low and the process maturity is low, then it is possible that availability would also be low, and the IT service provider has maximum opportunity to improve availability. Weightage to the dimension can be determined by a subject matter expert by considering various factors which affect the engineering impact. For example, “Platform Stability” has direct impact on the availability of the system, so it has the highest weight. Similarly, “Domain Complexity” has the maximum impact on the ability to do functional enhancement efficiently, so it has the maximum weightage.

### Example 33

### Exemplary Identification of Change Enablers for Facilitating Improvement in the Engineering Metrics

In any of the examples herein, change enablers for facilitating improvement in the engineering metrics can be identified. For example, one or more change enablers can be selected based on engineering metrics (e.g., that can be improved).

Given the engineering metrics, a list of possible applicable change enablers can be retrieved (e.g., from a database relating the change enablers to the engineering metrics).

The feasibility of implementing a change enabler in the client organization's context (e.g., deployment architecture, client permissions, nature of hardware needed, security restrictions, and the like) can be evaluated.

The change enablers can be ranked based on their feasibility of implementation in the organization.

### Example 34

### Exemplary System Filtering Change Enablers

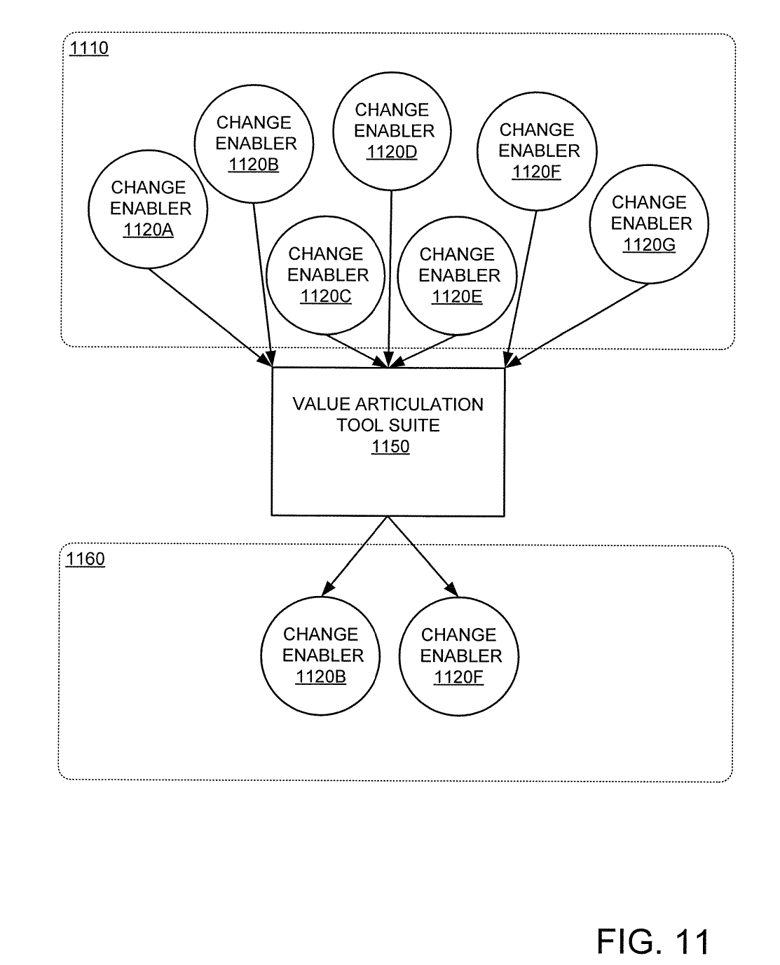

FIG. 11 is a block diagram of an exemplary system 1100 filtering change enablers 1110 via a business value articulation tool suite 1150. In any of the examples herein, tools can effectively serve as a filter to choose the change enablers 1160 appropriate for an organization (e.g., based on business context and the like).

In the example, the suite 1150 takes a set 1110 of change enablers 1120A-G as input and outputs some subset 1160 thereof.

### Example 35

### Exemplary Method of Filtering Change Enablers

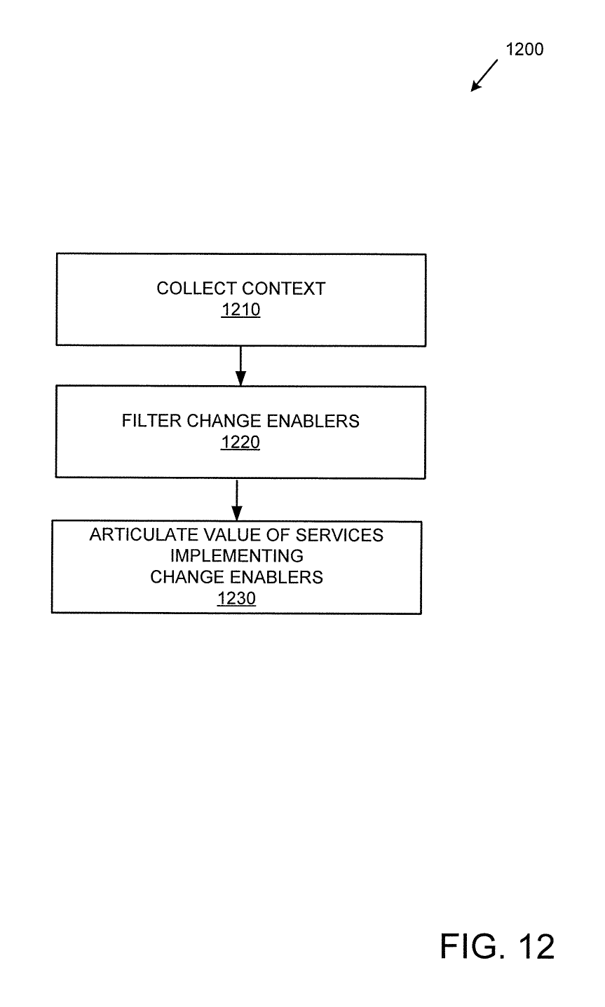

FIG. 12 is a flowchart of an exemplary method 1200 of filtering change enablers via a business value articulation tool suite and can be implemented, for example, in a system such as that shown in FIG. 11.

At 1210, a context for the organization is collected.

At 1220, the change enablers are filtered to remove those inappropriate for the organization (e.g., based on the collected context).

At 1230, value of IT services implementing the change enablers is articulated. For example, a business value articulation model showing connection between the change enabler and ultimate business value to the organization can demonstrate such connection.

### Example 36

### Exemplary System Applying a Business Value Articulation Framework

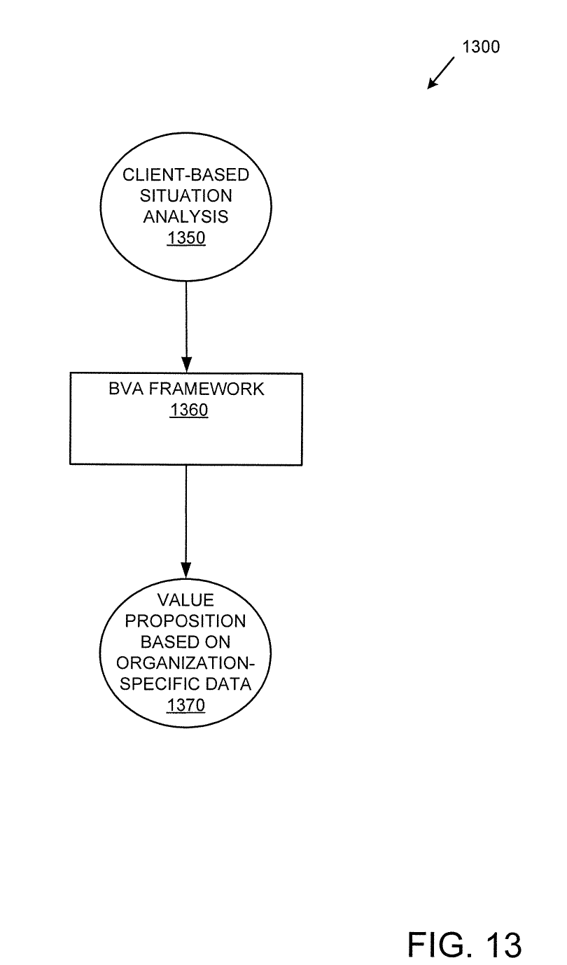

FIG. 13 is a block diagram of an exemplary system 1300 applying a business value articulation framework. In the example, a client-based situation analysis 1350 is applied in light of a business value articulation framework 1360 to yield a value proposition 1370 based on organization-specific data. As described herein, the framework can include a business value articulation model.

In any of the examples herein, the framework 1360 can be based on business-domain-independent services provided by an information technology services provider.

### Example 37

### Exemplary Business Value Articulation Model

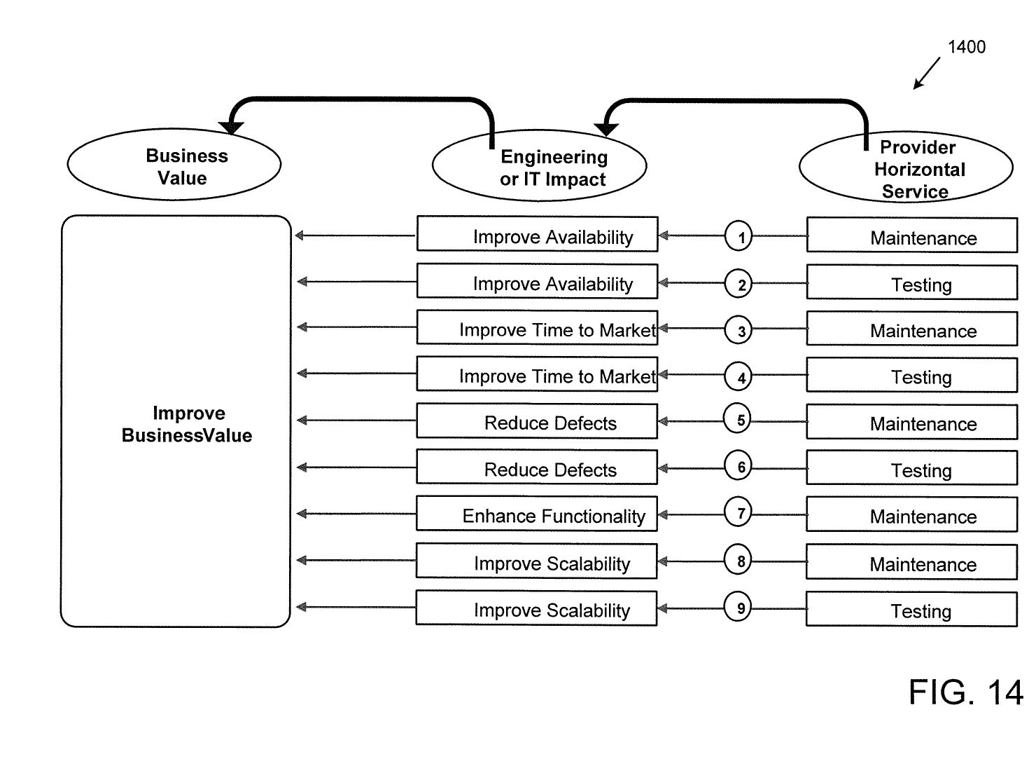

FIG. 14 is a block diagram of an exemplary business value articulation model 1400 and can be used for any of the business value articulation models described herein (e.g., the model part of framework 1360 of FIG. 13). In the example, a plurality of elements are connected to a generic “improve business value” element of type “business value.” In practice, the elements are represented by stored nodes.

Various service elements serve as change enablers. The change enablers are connected to engineering impacts (e.g., engineering fulcrums), which in turn are connected to ultimate business value.

### Example 38

### Exemplary Method of Applying Framework

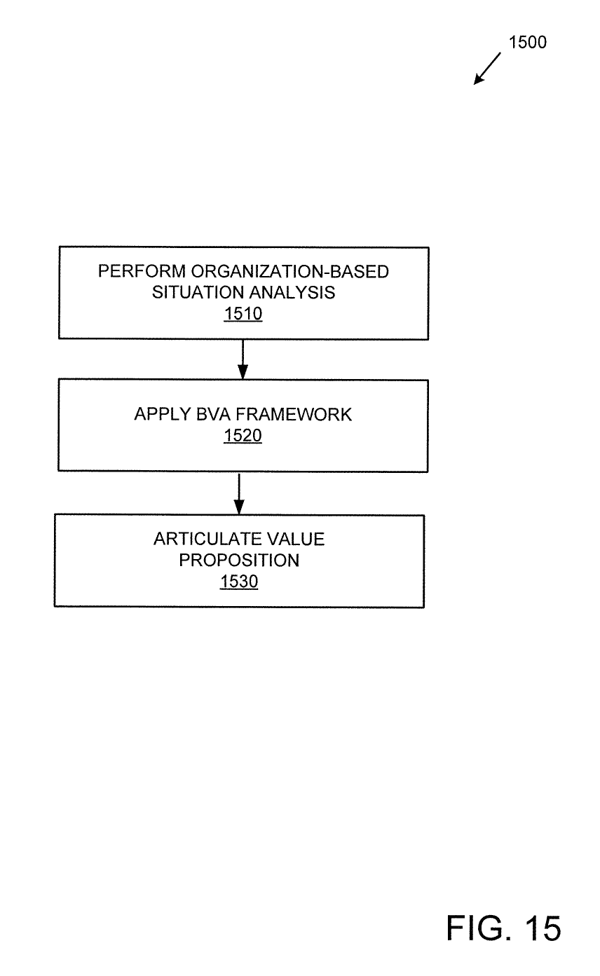

FIG. 15 is a flowchart of an exemplary method 1500 of applying a business value articulation framework via a business value articulation model and can be implemented, for example, in a system such as that shown in FIG. 13 in light of a business value articulation model, such as that shown in FIG. 14.

At 1510, an organization-based situation analysis is performed. For example, organization context information can be collected and the organization's situation can be analyzed with regard to the service provider's business-domain-independent services.

At 1520, a business value articulation framework is applied. Such a framework can include a business value articulation model. The framework can establish a link between the service provider's key enablers specific to a business-domain-independent service to the organization's value drivers. The model can include change enablers, engineering metrics, IT/Engineering impact, operational levers, value levers, and the like.

At 1530, the business value proposition is articulated based on organization-specific data. In practice, such articulation can comprise demonstrating a connection between a change enabler and ultimate business value (e.g., as indicated in the business value articulation model).

### Example 39

### Exemplary General Framework

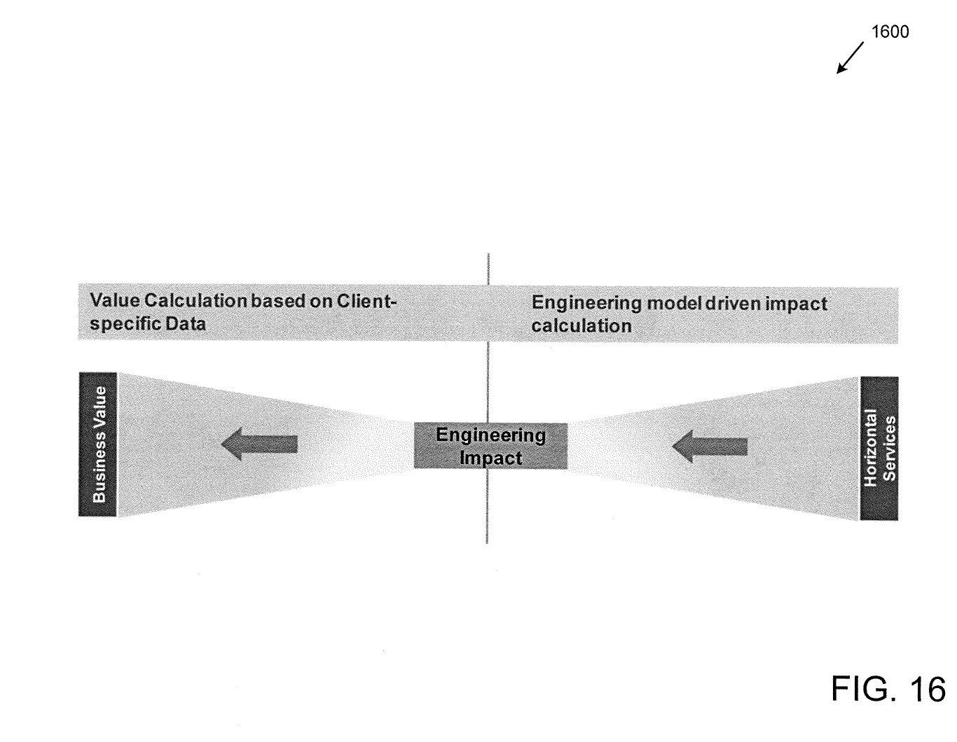

FIG. 16 is an exemplary general framework 1600 for achieving business value articulation. In the example, engineering impact serves as a fulcrum by which business-domain-independent services are recognized as resulting in ultimate business value to the organization.

The fulcrum connects engineering model driven impact calculation with value calculation based on organization-specific data.

### Example 40

### Exemplary Comprehensive Framework

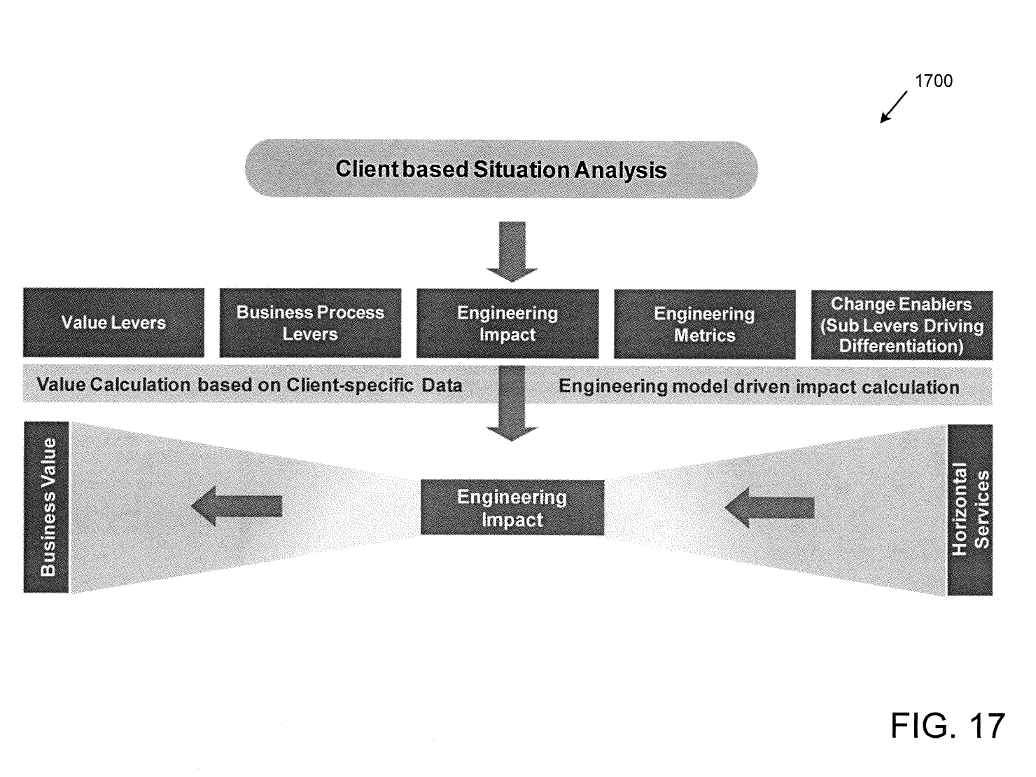

FIG. 17 is an exemplary comprehensive framework 1700 for achieving business value articulation. In the example, an organization-based situation analysis is applied to determine how business-domain-independent services result, via engineering impact, in business value for the organization.

Six element types are depicted: value levers, business process levers, engineering impact, engineering metrics, and change enablers. As shown herein, such elements can be identified and connected to articulate business value of implementing change enablers.

### Example 41

### Exemplary Business Processes

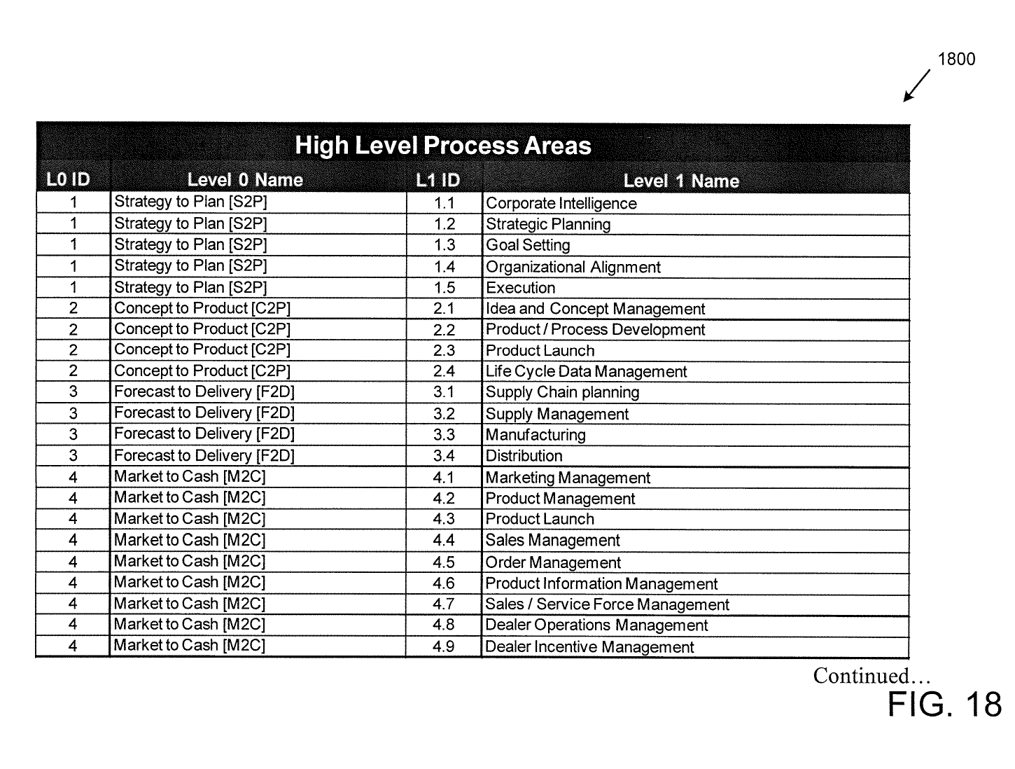

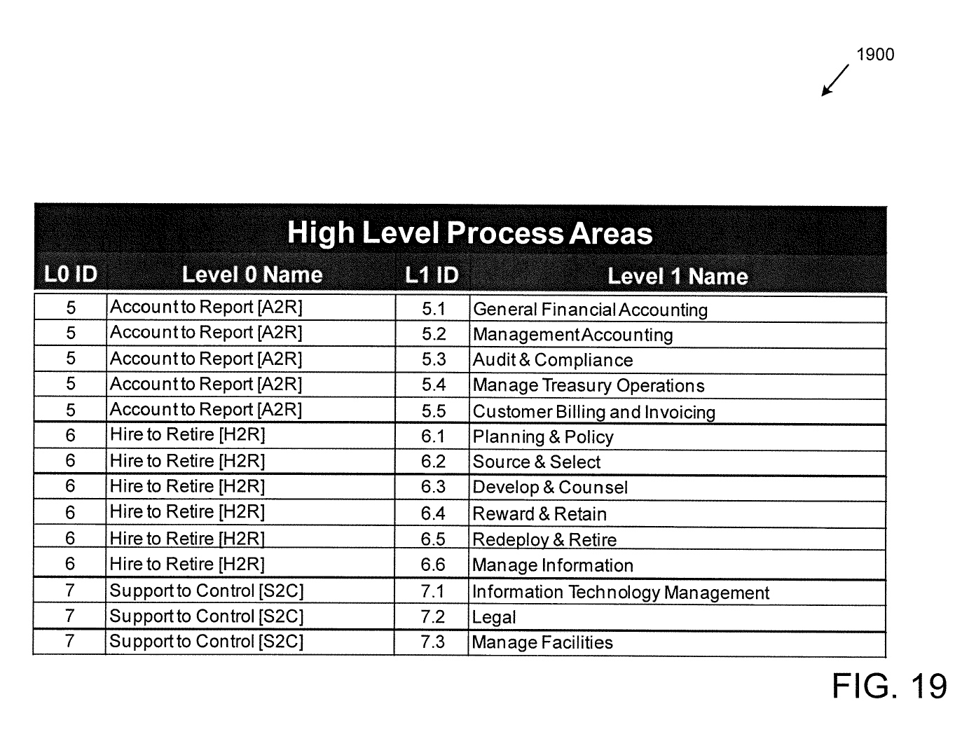

FIGS. 18 and 19 are an exemplary table 1800/1900 of exemplary business processes in the Retail, Consumer goods, Logistics (RCL) domain (e.g., level 0 and level 1). Business processes can be identified via the shown names. In practice, two names can be used: the level 0 name and the level 1 name. A same level 0 name typically applies to a plurality of level 1 names.

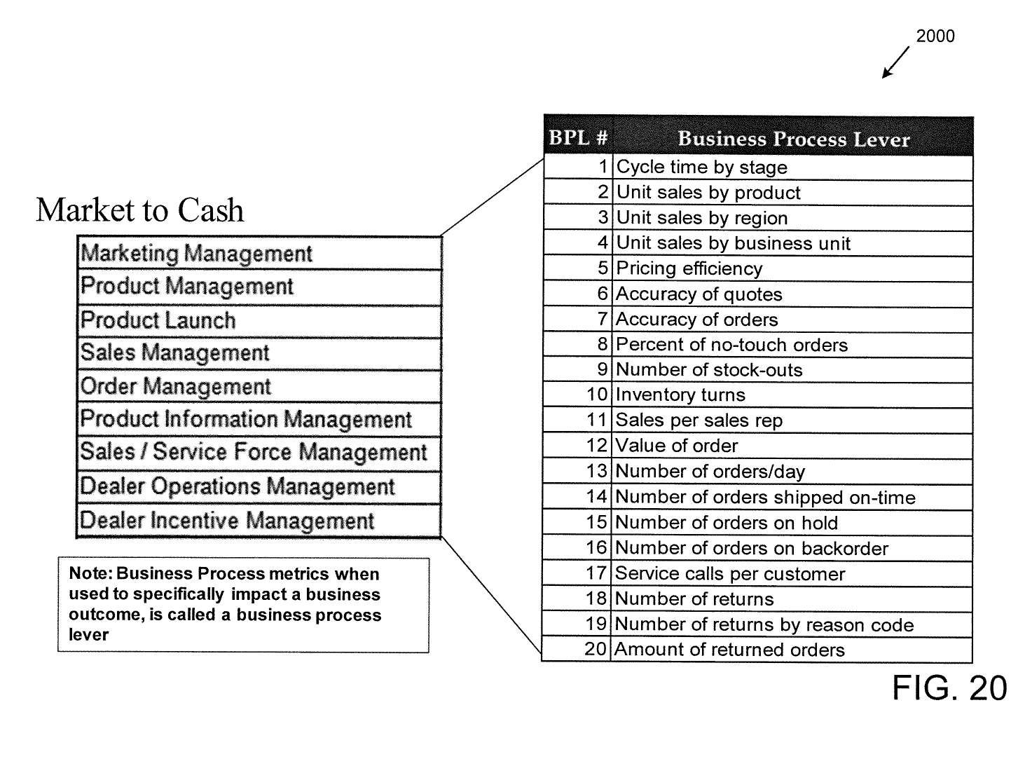

The business processes of level 0 “Market to Cash [M2C]” are shown with further treatment in FIG. 20 as described below.

In practice, any of a number of other domains and business processes can be used.

### Example 42

### Exemplary Business Process Levers

FIG. 20 is exemplary table 2000 of business process levers (e.g., metrics) related to business process names. The levers are for the Level 0 “Market to Cash” business processes having Level 1 as shown (e.g., Marketing Management, Product Management, etc.). Although the example applies to the RCL domain, any number of other domains can be supported. To represent the various business process metrics, a code can be used (e.g., BPL #) that identifies the business process lever. The code can be used in conjunction with another identifier (e.g., level 0 identifier, level 1 identifier, or both) to uniquely identify the business process metric, thereby saving storage space and providing a uniform taxonomy for representation across business value articulation models across different organizations (e.g., for an IT services provider).

In practice, any number of other business processes can be used.

Business process levers can be identified via the shown names. In practice, the associated business process identifiers can be stored with the business process lever to identify an element (e.g., in a model).

### Example 43

### Exemplary Business Process Articulation Model Progression

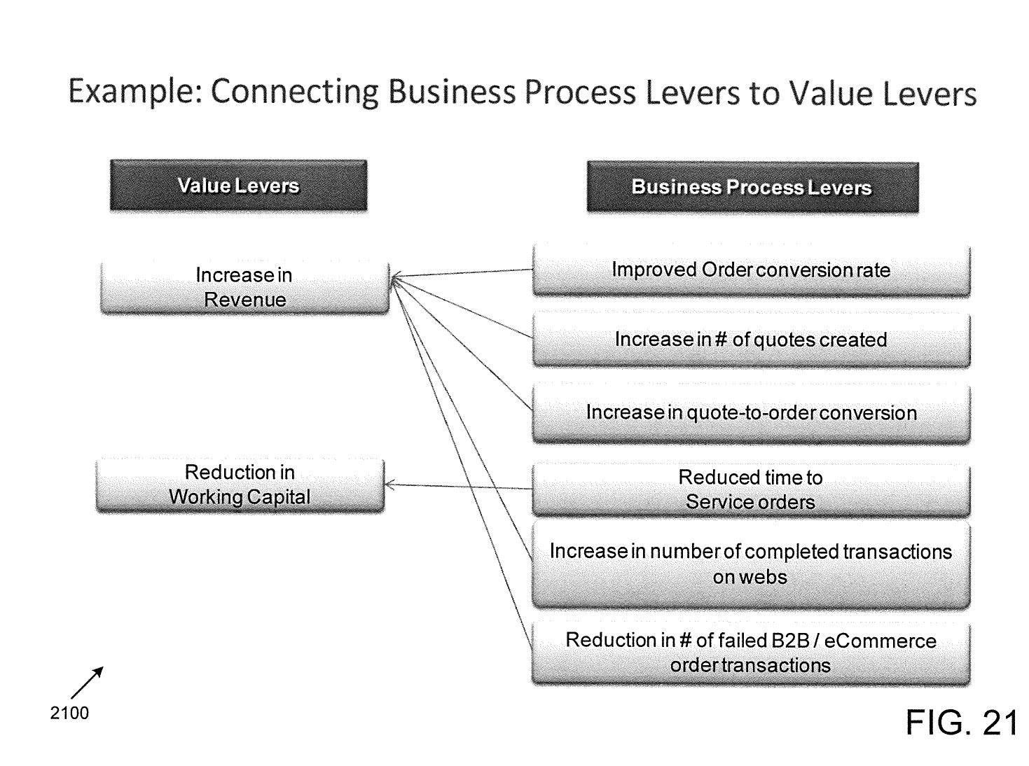

FIG. 21 is an exemplary partially-completed model 2100 for business value articulation. In the example, nodes for the various elements are stored as part of the model. Various business process levers are connected to value levers as shown. Although the example is for order processing business processes, any number of other domains can be supported.

The business process levers are those business process metrics that have been determined as those that can be enhanced to improve the business value of the organization.

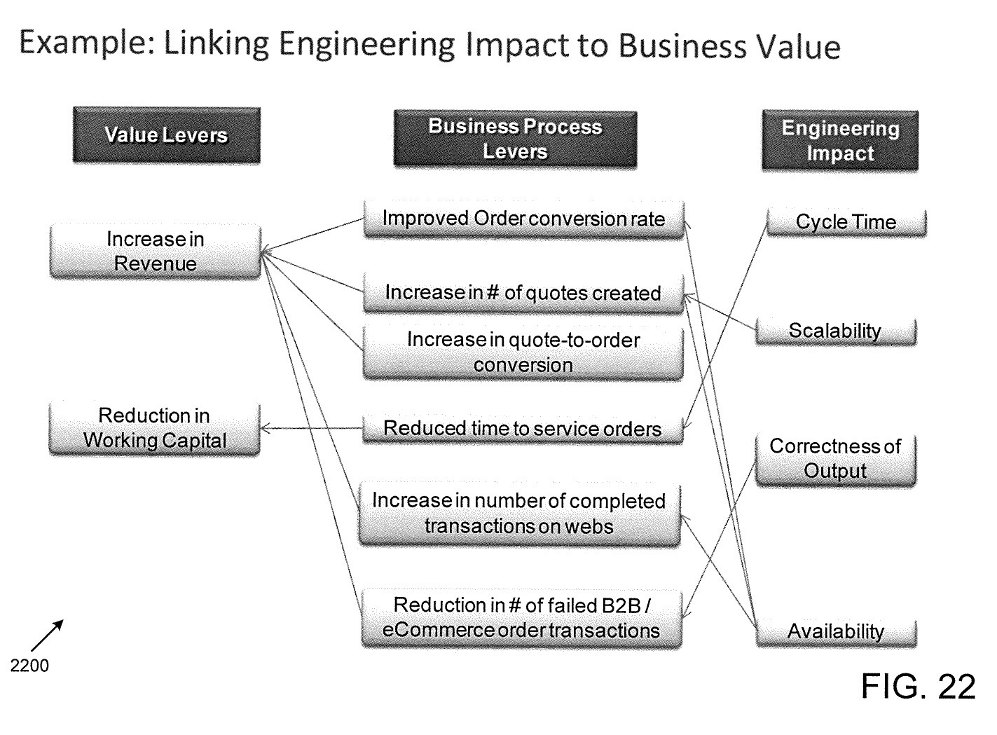

FIG. 22 is an exemplary further completed model 2200 for business value articulation. In the example, engineering impacts are connected to business process levers. The engineering impacts (e.g., information technology outcomes) help in enhancing business processes (e.g., for order processing), and in turn the business value.

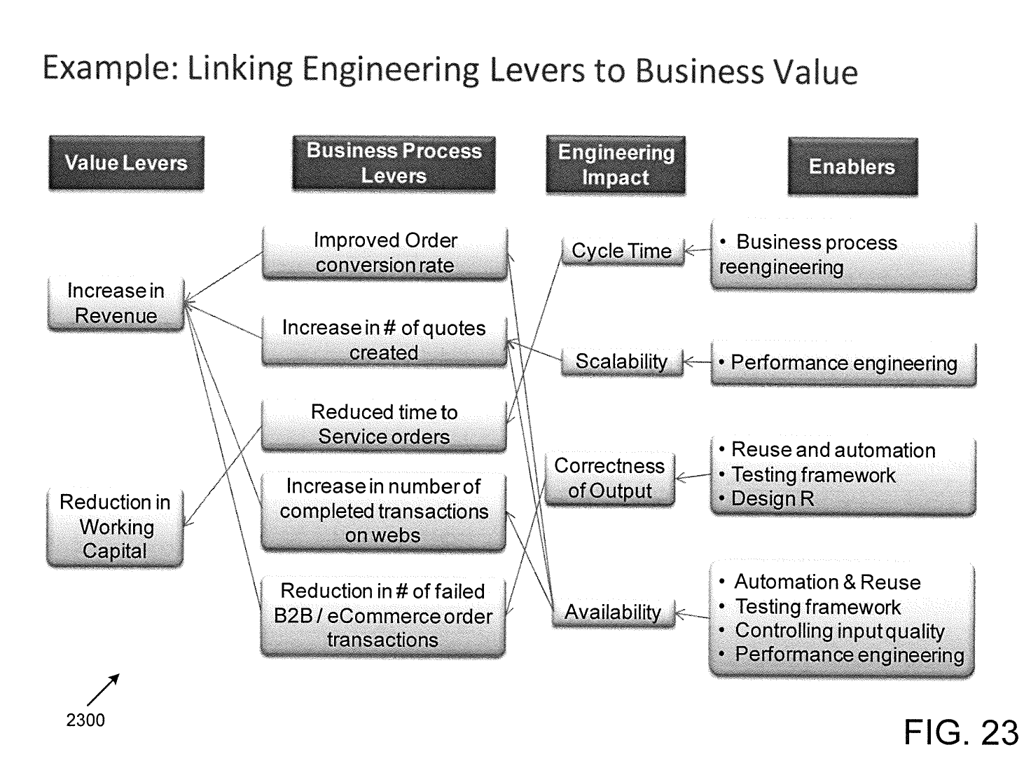

FIG. 23 is an exemplary further completed model 2300 for business value articulation. In the example, change enablers are connected to engineering impacts. The change enablers can come out of one or more business-domain-independent service lines.

The completed model 2300 can be used for business value articulation. For example, it can be shown that controlling input quality will result in greater availability, which will result in an improved order conversion rate, which will lead to an increase in revenue. Such a concrete illustration can be persuasive to the organization that an information technology services provider should implement the change enablers because it demonstrates how investment in the change enablers will result in ultimate business value to the organization.

### Example 44

### Exemplary Model

In an exemplary application of the technologies herein, a business process metric was based on comparison with industry benchmarks. In the example, the metric “number of completed transactions in on-line channel” had an industry benchmark of a particular value (e.g., 99.8% for best in class for the industry). In the organization, the metric was less, and the organization thus would want to improve it.

To effect improvement, an engineering impact to improve the business process metric is selected. For example, the engineering impact “availability of the system” should be improved to increase the number of completed transactions. The business process metric is then linked to the engineering impact.

An engineering metric to improve the engineering impact “availability of the system” is chosen. For example, it is found that the engineering metric “number of releases/patches delivered without defects” should be increased. The engineering impact is then linked to the engineering metric.

### Example 45

### Exemplary Model

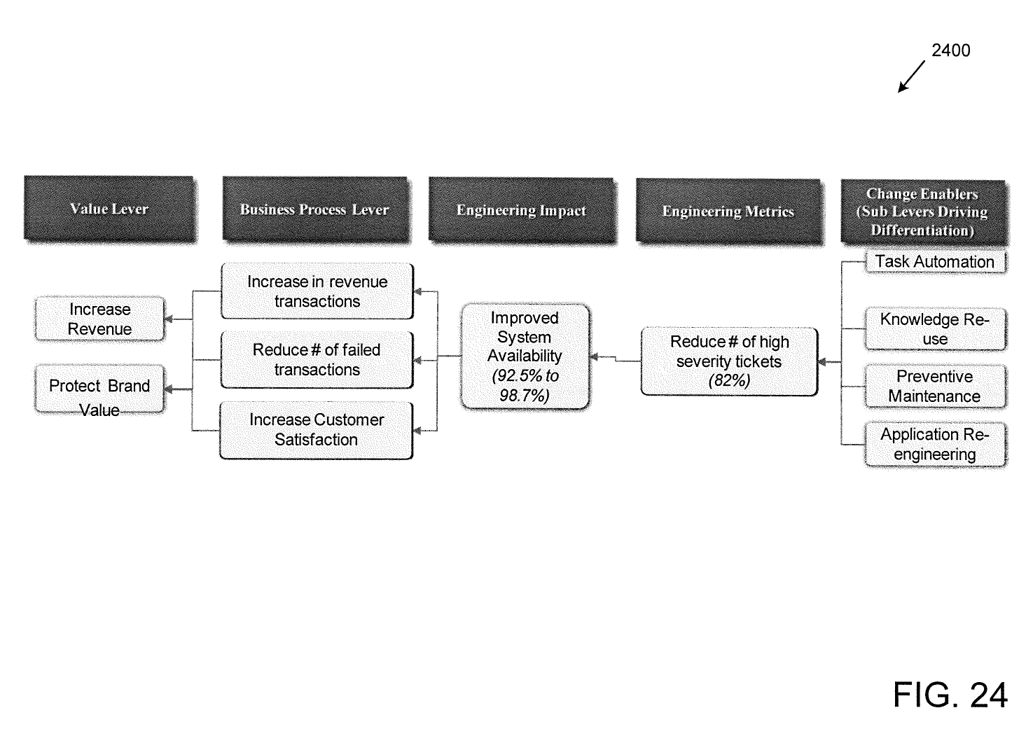

FIG. 24 is an exemplary business value articulation model 2400 for the banking industry in the service/maintenance domain. The model demonstrates how improved system availability of a cash management process led to increased fee income.

A situation analysis for the organization revealed that transaction banking—cash management systems were being supported by an IT service provider. The systems included payment channels, wires, and cash management. The organization generated reveunue by providing its commercial, non-retail customers with alternate payment routes that were less expensive than conventional routes.

However, a delay in processing the payment transactions would lead to overdraft fees being incorrectly charged to the organization's customers, resulting in loss of reputation and loss of fee generating volumes.

The IT service provider proposed a program whose objective was to reduce high priority incidents and implement long term solutions.

Fixes ranged from process optimization, intervention in the change management process to ensure that releases do not introduce potential outage bugs, carrying out fixes as part of the maintenance releases, and changes to hardware.

### Example 46

### Exemplary Model

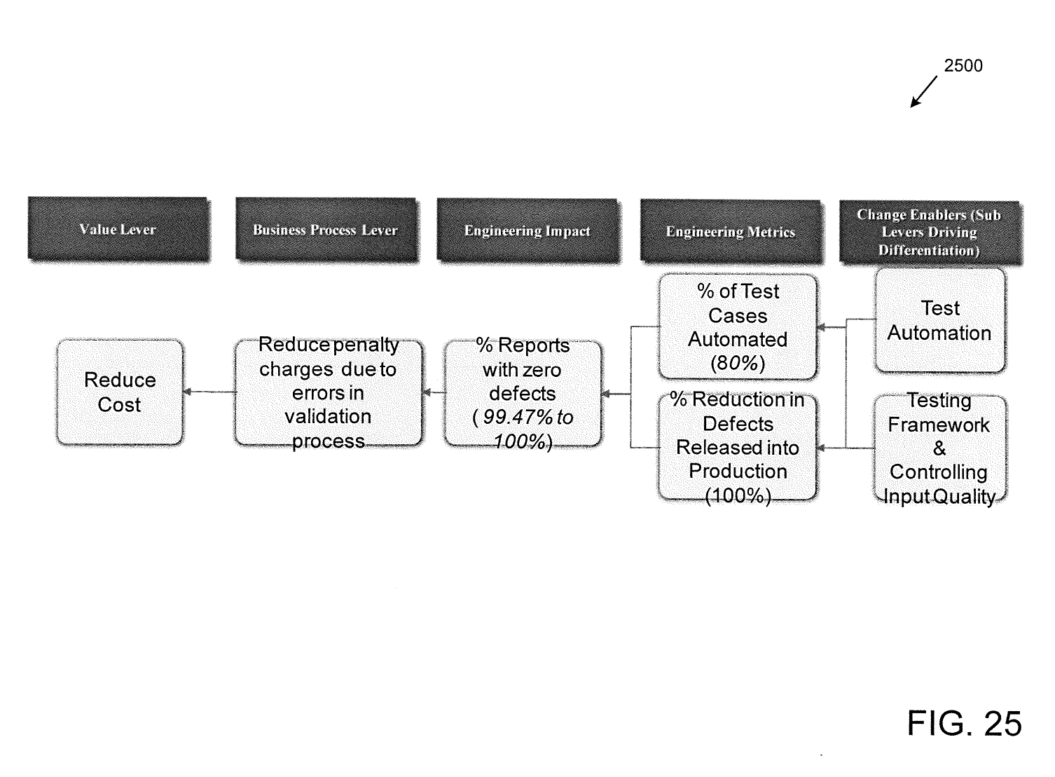

FIG. 25 is an exemplary business value articulation model 2500 for the investment banking industry in the service/independent validation services domain. The model demonstrates how improvement in data validation quality helped avoid the cost of regulatory penalties.

A situation analysis revealed that the system that was being validated comes under the research publishing platform of an investment bank and was being used to create research material on various companies, sectors, economies, and the like.

A typical research note released by an investment bank should contain appropriate disclaimers and disclosures, and is closely regulated. Any omission in disclaimers can attract a heavy regulatory penalty.

The IT service provider targeted defect free delivery so that any data errors in rules and regulatory information are avoided to avoid the penalties. Data validation was originally a manual process and resulted in errors.

Reducing the manual testing effort along with automated validation helped ensure zero defect regulatory reporting and also ensured scalability of the testing process. Any new addition of test cases can be done without significant changes.

### Example 47

### Exemplary Model

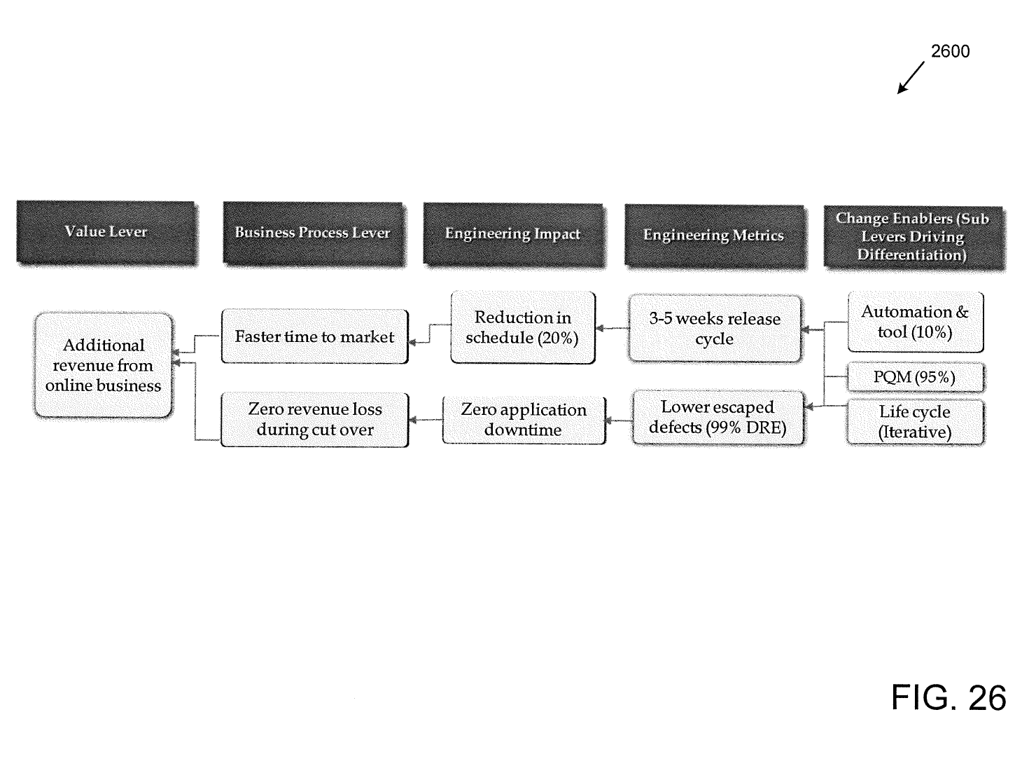

FIG. 26 is an exemplary business value articulation model 2600 for a broadline retailer in the service/development domain. The model demonstrates how faster time to market helped the organization transform its ecommerce capacity into revenue growth.

A situation analysis revealed that the organization was a top retailer, but its online sales were relatively low. There were various store fronts to be integrated after a merger.

The organization aspired to be best in class in sales/time to market by providing a richer customer experience and faster time to market.

The IT Services provider and the organization aimed to create a scalable integrated web platform unshackled from disparate sites and the old obsolete/non-scalable platform by implementing enterprise-wide system standards. The customer saved several million dollars in capital investment in the project.

### Example 48

### Exemplary Model

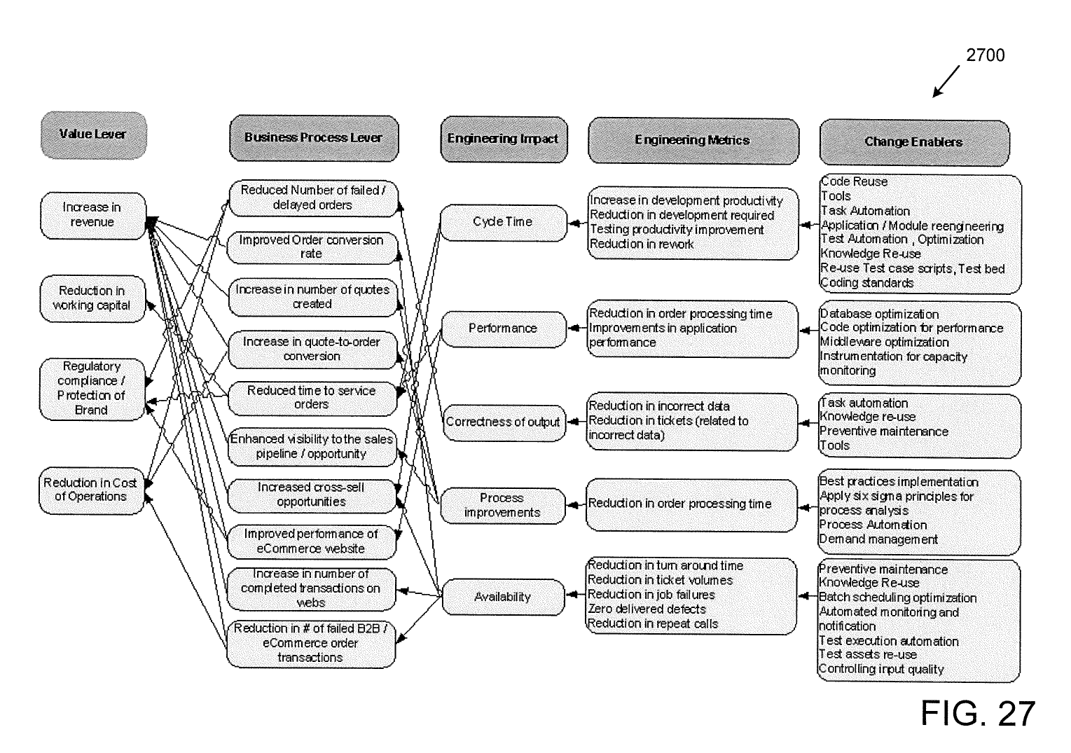

FIG. 27 is an exemplary business value articulation model 2700 for order processing.

### Example 49

### Exemplary Computing Environment

The techniques and solutions described herein can be performed by software, hardware, or both of a computing environment, such as one or more computing devices. For example, computing devices include server computers, desktop computers, laptop computers, notebook computers, netbooks, tablet devices, mobile devices, and other types of computing devices.

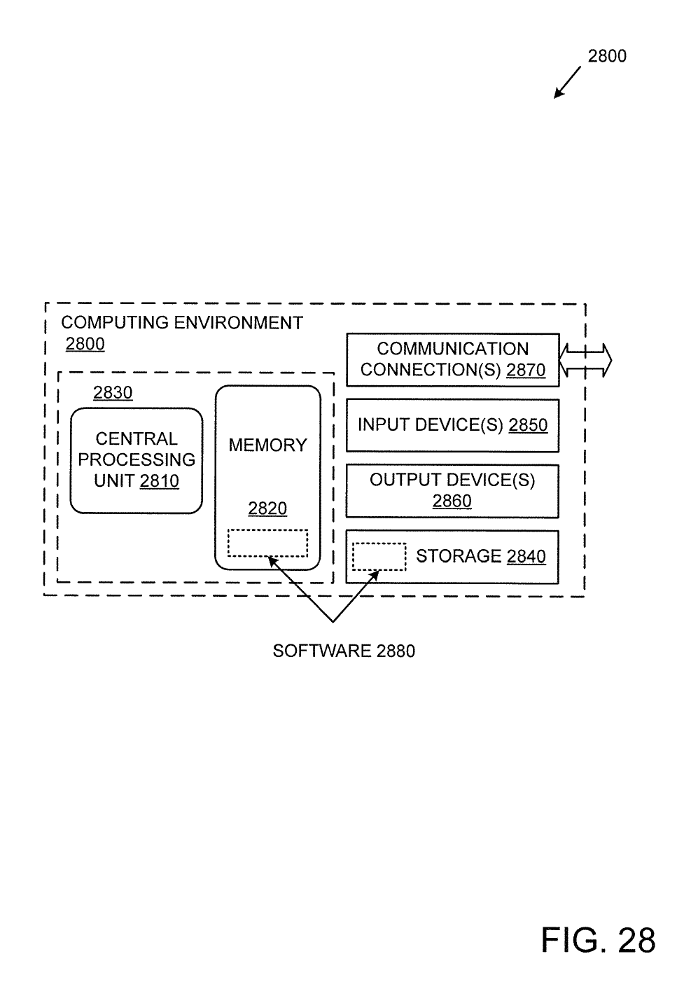

FIG. 28 illustrates a generalized example of a suitable computing environment 2800 in which the described technologies can be implemented. The computing environment 2800 is not intended to suggest any limitation as to scope of use or functionality, as the technologies may be implemented in diverse general-purpose or special-purpose computing environments. For example, the disclosed technology may be implemented using a computing device (e.g., a server, desktop, laptop, hand-held device, mobile device, PDA, etc.) comprising a processing unit, memory, and storage storing computer-executable instructions implementing the business value articulation described herein. The disclosed technology may also be implemented with other computer system configurations, including hand held devices, multiprocessor systems, microprocessor-based or programmable consumer electronics, network PCs, minicomputers, mainframe computers, a collection of client/server systems, and the like. The disclosed technology may also be practiced in distributed computing environments where tasks are performed by remote processing devices that are linked through a communications network. In a distributed computing environment, program modules may be located in both local and remote memory storage devices

With reference to FIG. 28, the computing environment 2800 includes at least one processing unit 2810 coupled to memory 2820. In FIG. 28, this basic configuration 2830 is included within a dashed line. The processing unit 2810 executes computer-executable instructions and may be a real or a virtual processor. In a multi-processing system, multiple processing units execute computer-executable instructions to increase processing power. The memory 2820 may be volatile memory (e.g., registers, cache, RAM), non-volatile memory (e.g., ROM, EEPROM, flash memory, etc.), or some combination of the two. The memory 2820 can store software 2880 implementing any of the technologies described herein.

A computing environment may have additional features. For example, the computing environment 2800 includes storage 2840, one or more input devices 2850, one or more output devices 2860, and one or more communication connections 2870. An interconnection mechanism (not shown) such as a bus, controller, or network interconnects the components of the computing environment 2800. Typically, operating system software (not shown) provides an operating environment for other software executing in the computing environment 2800, and coordinates activities of the components of the computing environment 2800.

The storage 2840 may be removable or non-removable, and includes magnetic disks, magnetic tapes or cassettes, CD-ROMs, CD-RWs, DVDs, or any other computer-readable media which can be used to store information and which can be accessed within the computing environment 2800. The storage 2840 can store software 2880 containing instructions for any of the technologies described herein.

The input device(s) 2850 may be a touch input device such as a keyboard, mouse, pen, or trackball, a voice input device, a scanning device, or another device that provides input to the computing environment 2800. For audio, the input device(s) 2850 may be a sound card or similar device that accepts audio input in analog or digital form, or a CD-ROM reader that provides audio samples to the computing environment. The output device(s) 2860 may be a display, printer, speaker, CD-writer, or another device that provides output from the computing environment 2800.

The communication connection(s) 2870 enable communication over a communication mechanism to another computing entity. The communication mechanism conveys information such as computer-executable instructions, audio/video or other information, or other data. By way of example, and not limitation, communication mechanisms include wired or wireless techniques implemented with an electrical, optical, RF, infrared, acoustic, or other carrier.

The techniques herein can be described in the general context of computer-executable instructions, such as those included in program modules, being executed in a computing environment on a target real or virtual processor. Generally, program modules include routines, programs, libraries, objects, classes, components, data structures, etc., that perform particular tasks or implement particular abstract data types. The functionality of the program modules may be combined or split between program modules as desired in various embodiments. Computer-executable instructions for program modules may be executed within a local or distributed computing environment.

### Storing in Computer-Readable Media

Any of the storing actions described herein can be implemented by storing in one or more computer-readable media (e.g., computer-readable storage media or other tangible media).

Any of the things described as stored can be stored in one or more computer-readable media (e.g., computer-readable storage media or other tangible media).

### Methods in Computer-Readable Media

Any of the methods described herein can be implemented by computer-executable instructions in (e.g., encoded on) one or more computer-readable media (e.g., computer-readable storage media or other tangible media). Such instructions can cause a computer to perform the method. The technologies described herein can be implemented in a variety of programming languages.

### Methods in Computer-Readable Storage Devices

Any of the methods described herein can be implemented by computer-executable instructions stored in one or more computer-readable storage devices (e.g., memory, CD-ROM, CD-RW, DVD, or the like). Such instructions can cause a computer to perform the method.

### Alternatives

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. We therefore claim as our invention all that comes within the scope and spirit of these claims.

We claim:

1. A method, implemented at least in part by a computing device, the method comprising:
receiving business context information for an organization in an industry;
receiving industry benchmark information for the industry;
based on the business context information for the organization and the industry benchmark information for the industry, connecting at least one aspect of information technology design representation with a representation of ultimate business value to the organization, wherein connecting comprises representing at least one change enabler based on the business context information and the industry benchmark information and establishing a multi-step connection between the representation of the change enabler and the representation of ultimate business value to the organization; and
articulating business value, to the organization, of information technology services implementing the at least one change enabler, wherein articulating business value comprises indicating the multi-step connection between the representation of the change enabler and the representation of ultimate business value to the organization.

2. One or more computer-readable storage devices having encoded therein computer-executable instructions causing a computer to perform the method of claim 1.

3. The method of claim 1 wherein connecting at least one aspect of information technology design representation with ultimate business value to the organization comprises:
constructing a business value articulation model representing connections between elements.

4. The method of claim 3 wherein:
the elements comprise at least one change enabler element representing the at least one change enabler and a business value element representing the ultimate business value; and
the multi-step connection transitively connects the change enabler element and the business value element.

5. The method of claim 3 wherein constructing the business value articulation model comprises:
in the business value articulation model comprising nodes and connections, storing a relationship between a change enabler element and an engineering metric element;
in the business value articulation model, storing a relationship between the engineering metric element and a business process metric element; and
in the business value articulation model, storing a relationship between the business process metric element and a business value element.

6. The method of claim 1 wherein connecting comprises:
identifying one or more critical business processes on basis of impact on the ultimate business value of the organization;
identifying at least one key business process metric of the one or more critical business processes; and
comparing the at least one key business process metric as observed within the organization with the at least one key business process metric as indicated in the industry benchmark information for the industry.

7. The method of claim 6 wherein connecting further comprises:
based on results of the comparing, identifying an improvable business process metric out of the at least one key business process metric.

8. The method of claim 7 wherein the improvable business process metric is identified in a business value articulation model via a business process lever identifier.

9. The method of claim 1 wherein identifying at least one change enabler comprises:
filtering a set of possible change enablers.

10. The method of claim 1 wherein articulating business value of the at least one change enabler comprises:
presenting the change enabler as a differentiator over a competing information technology services provider.

11. The method of claim 1 wherein articulating business value of the at least one change enabler comprises:
presenting the change enabler as a unique differentiator over a competing information technology services provider.

12. A system comprising:
one or more processors coupled to memory;
a business value articulation model comprising elements stored in one or more computer-readable storage media, wherein the elements comprise an element representing business value to an organization, an element representing a change enabler, and at least one other element, wherein the elements are connected demonstrating influence between the elements.

13. The system of claim 12 wherein elements of the business value articulation model comprise respective element names and respective element types.

14. The system of claim 13 wherein the element types comprise:
change enabler;
business value;
business process metric; and
engineering metric.

15. The system of claim 14 wherein the element names for elements of type business value are one or more selected from the group consisting of:
increasing revenue;
reducing cost; and
reduction in working capital.

16. The system of claim 15 wherein the change enabler represents at least one business-domain-independent service provided by an information technology services provider.

17. The system of claim 15 wherein at least one of the elements represents a business process metric selected from the group consisting of:
cycle time by stage;
unit sales by product;
unit sales by region;
unit sales by business unit;
pricing efficiency;
accuracy of quotes;
accuracy of orders;
percent of no-touch orders;
number of stock-outs;
inventory turns;
sales per sales representative;
value of order;
number of orders per day;
number of orders shipped on-time;
number of orders on hold;
number of orders on backorder;
service calls per customer;
number of returns;
number of returns by reason code; and
amount of returned orders.

18. The system of claim 16 wherein the business process metric is represented via a business process lever identifier.

19. The system of claim 18 wherein the business process lever identifier, in combination with a business process level identifier, uniquely identifies the business process metric across business value articulation models across different organizations for an information technology services provider.

20. One or more computer-readable storage devices having stored therein computer-executable instructions for performing a method comprising:
receiving business context information for an organization in an industry;
receiving information technology context information for the organization;
receiving industry benchmark information for the industry;
based on the business context information for the organization, the industry benchmark information for the industry, identifying one or more critical business processes on a basis of impact of the critical business processes on business value elements for the organization;
identifying one or more key metrics of the critical business processes;
for the key metrics, comparing observed performance in the organization with the industry benchmark information for the industry;
based on the comparing, identifying one or more improvable metrics out of the key metrics of the critical business processes;
identifying one or more engineering impacts that will impact the improvable metrics;
identifying one or more engineering metrics that will impact the engineering impacts;
identifying change enablers for the engineering metrics;
storing, in one or more computer-readable media, a business value articulation model comprising nodes representing at least one of identified business value elements, identified improvable metrics, identified engineering impacts, identified engineering metrics, and identified change enablers; and
connecting the nodes to each other via connections representing influence of one element on another.

21. The one or more computer-readable storage devices of claim 20 wherein the business value articulation model represents at least one improvable metric via a level zero identifier selected from the group consisting of:
strategy to plan;
concept to product;
forecast to deliver;
market to cash;
account to report;
hire to retire; and
support to control.
